(19) United States
(12) Patent Application Publication
(10) Pub. No.: US 2007/0038477 A1
(43) Pub. Date: Feb. 15, 2007

(54) Maintaining and communicating health information

(75) Inventors: Margie M. Kelly, Athens, GA (US); Jason P. Blackburn, Alto, GA (US); Donald M. Bagwell, Cornelia, GA (US)

Correspondence Address: KING & SPALDING LLP, 1180 PEACHTREE STREET, ATLANTA, GA, 30309-3521, US

(73) Assignee: Kelly Company, LLC, Athens, GA (US)

(21) Appl. No.: 11/503,753

(22) Filed: Aug. 14, 2006

Related U.S. Application Data
(60) Provisional application No. 60/708,176, filed on Aug. 15, 2005.

(51) Int. Cl. G06F 19/00

(52) U.S. Cl. 705/3

(57) ABSTRACT

A patient record is created from data received from a network device and is stored in a database. The data represents patient information and possibly other personal data. A plurality of access privileges may be associated with the patient record, each of which may specify a different type or amount of the data of the patient record that can be viewed, updated and revised. A selected portion of the patient record may be designated as emergency information that would be helpful to a caregiver during a medical emergency. An emergency reference code can be associated with the emergency information. In response to receiving the emergency reference code from a user device via the network, the emergency information may be displayed. An interface is also provided for allowing a user having appropriate access privileges to create and print a customized card comprising portions of the patient record selected by the user.

### RELATED PATENT APPLICATION

This application claims priority under 35 U.S.C. § 119 to U.S. Provisional Patent Application No. 60/708,176, entitled “Maintaining and Communicating Health Information,” filed Aug. 15, 2005, the complete disclosure of which is hereby fully incorporated herein by reference.

### FIELD OF THE INVENTION

The present invention relates generally to maintaining and communicating health information, and more particularly to providing a network based application through which patients can maintain, and communicate to designated health care providers, their health information, and to providing each patient with a customized card comprising certain of the patient's health information.

### BACKGROUND OF THE INVENTION

A patient's health is ultimately his own responsibility. To stay healthy, patients should take active interests in their health. In particular, they should be informed about, and be able to effectively communicate, their medical needs and medical history.

One important way that a patient can take an active interest in his health is to maintain an accurate health record. A health record can include information related to the patient's health (“health information”), including, e.g., the patient's contact information, age, emergency contact, physicians, allergies, medications and medical devices, medical history, immunizations, and health insurance. Traditionally, patients have relied on each of their health care providers to maintain such a record. For example, for each of a physician's patients, the physician typically maintains a file comprising the patient's health information (a “health file”). Patients generally do not have ready access to their health files and cannot easily examine, update, correct, or communicate to others, the information contained therein.

Many physicians are only willing to provide a patient with a copy of his health file for a fee. After a patient pays to obtain a copy of each of his health files, he must separately evaluate each file and compile the information contained therein. To update or correct errors in the files, the patient must call, or otherwise submit information to, each physician about the update/error. Many patients are unable, or are unwilling to expend the resources necessary, to review, revise, and compile information from, each of their health files. As a result, patients traditionally have been unable to maintain an accurate health record.

Instead, many patients have tried to memorize most, if not all, of their health information. To communicate their health information, for example to a health care provider, such patients must be able to recall the information. For many patients, recalling health information can be difficult and time consuming; for some patients, including some elderly patients and patients suffering from Alzheimer's disease, it may be impossible. Even if they can recall their health information, some patients are unable to effectively communicate the information. For example, certain patients are mute, and thus are unable to speak about their health information. In addition, in certain emergency situations, e.g., when a patient becomes unconscious, the patient cannot communicate necessary health information, including the patient's name, emergency contact information, and allergies.

In view of the foregoing, there is a present need for a more convenient and effective approach for patients to maintain their health information. In addition, there is a need for such health information to be readily accessible, updatable, and communicable. The present invention solves these needs.

### SUMMARY OF THE INVENTION

The present invention provides systems and methods for maintaining and communicating health information. In accordance with certain aspects of the invention, data representing patient health information and other personal data is transmitted via a network from a network device to a server, for example by way of a web page. Patient health information may include information such as patient contact information, age, emergency contact information, physicians, dentists, allergies, medications, medical devices, medical history, immunizations, and health insurance. Other personal data may include patient name, address, telephone number, sex, birth date, blood type, height, weight, social security number, living will information, and organ donor status. A patient record is created from the data and is stored in a health information database.

A plurality of access privileges may be associated with the patient record, each of which may specify a different type or amount of the data of the patient record that can be viewed, updated and revised. A selected portion of the patient record may also be designated as emergency information that would be helpful to a caregiver during a medical emergency. The emergency information may include, for example, patient name, emergency contact, allergies, current medications, and medical history. An emergency reference code can be associated with the emergency information. In response to receiving the emergency reference code from a user device via the network, the emergency information may be displayed.

An interface may also be provided for allowing a user having appropriate access privileges to create and print a customized card comprising portions of the patient record selected by the user. The interface may be configured to allow the user to determine the size and the format of the customized card.

### BRIEF DESCRIPTION OF THE DRAWINGS

FIG. 1 is a block diagram illustrating an exemplary operating environment for implementation of various embodiments of the present invention.

FIG. 2 is a block diagram illustrating a general component architecture for a network device constructed in accordance with an exemplary embodiment of the present invention.

FIG. 3 is a flow chart illustrating steps in a method for maintaining and communicating health information, according to an exemplary embodiment of the present invention.

FIG. 4 is an illustrative welcome page of a system for maintaining and communicating health information, according to an exemplary embodiment of the present invention.

FIG. 5 is an illustrative print customized card page of a system for maintaining and communicating health information, according to an exemplary embodiment of the present invention.

FIG. 6 illustrates a customized card comprising certain of a patient's health information, according to an exemplary embodiment of the present invention.

FIG. 7 is an illustrative menu page of a system for maintaining and communicating health information, according to an exemplary embodiment of the present invention.

FIG. 8 is an illustrative personal data details page of a system for maintaining and communicating health information, according to an exemplary embodiment of the present invention.

FIG. 9 is an illustrative personal data edit page 1 of a system for maintaining and communicating health information, according to an exemplary embodiment of the present invention.

FIG. 10 is an illustrative personal data edit page 2 of a system for maintaining and communicating health information, according to an exemplary embodiment of the present invention.

FIG. 11 is an illustrative living will information page of a system for maintaining and communicating health information, according to an exemplary embodiment of the present invention.

FIG. 12 is an illustrative physicians list page of a system for maintaining and communicating health information, according to an exemplary embodiment of the present invention.

FIG. 13 is an illustrative physicians details page of a system for maintaining and communicating health information, according to an exemplary embodiment of the present invention.

FIG. 14 is an illustrative physicians edit page of a system for maintaining and communicating health information, according to an exemplary embodiment of the present invention.

FIG. 15 is an illustrative emergency contacts details page of a system for maintaining and communicating health information, according to an exemplary embodiment of the present invention.

FIG. 16 is an illustrative emergency contacts edit page of a system for maintaining and communicating health information, according to an exemplary embodiment of the present invention.

FIG. 17 is an illustrative insurers details page of a system for maintaining and communicating health information, according to an exemplary embodiment of the present invention.

FIG. 18 is an illustrative insurers edit page of a system for maintaining and communicating health information, according to an exemplary embodiment of the present invention.

FIG. 19 is an illustrative current medications list page of a system for maintaining and communicating health information, according to an exemplary embodiment of the present invention.

FIG. 20 is an illustrative current medications details page of a system for maintaining and communicating health information, according to an exemplary embodiment of the present invention.

FIG. 21 is an illustrative current medications edit page of a system for maintaining and communicating health information, according to an exemplary embodiment of the present invention.

FIG. 22 is an illustrative medical history list page of a system for maintaining and communicating health information, according to an exemplary embodiment of the present invention.

FIG. 23 is an illustrative medical history details page of a system for maintaining and communicating health information, according to an exemplary embodiment of the present invention.

FIG. 24 is an illustrative medical history edit page of a system for maintaining and communicating health information, according to an exemplary embodiment of the present invention.

FIG. 25 is an illustrative immunization list page of a system for maintaining and communicating health information, according to an exemplary embodiment of the present invention.

FIG. 26 is an illustrative immunization details page of a system for maintaining and communicating health information, according to an exemplary embodiment of the present invention.

FIG. 27 is an illustrative immunization edit page of a system for maintaining and communicating health information, according to an exemplary embodiment of the present invention.

FIG. 28 is an illustrative allergies list page of a system for maintaining and communicating health information, according to an exemplary embodiment of the present invention.

FIG. 29 is an illustrative dental record page of a system for maintaining and communicating health information, according to an exemplary embodiment of the present invention.

### DETAILED DESCRIPTION

The present invention provides systems and methods for maintaining and communicating health information. In particular, the present invention provides a network based application through which patients can maintain, and communicate to designated health care providers, their health information. Such an application can enable patients to take more control over their health by keeping themselves and their health care providers informed about their medical needs and medical history. In one embodiment of the present invention, patients can authorize designated health care providers to update and/or revise certain of their health information. By allowing health care providers to make such updates/revisions, patients can maintain a more accurate record of their health information.

The present invention further enables each patient to create a customized card comprising certain of the patient's health information. Each patient can access his customized card to quickly review his health information and to efficiently communicate that information to others. For example, the patient can communicate certain of his health information to his health care provider simply by handing his customized card to the health care provider. When a patient is suffering from a medical emergency, others can access the patient's customized card to immediately learn important information about the patient, such as the patient's name, emergency contact, current medications, allergies, and medical history, which can be used in treating the patient. In one embodiment of the present invention, patients can authorize designated health care providers to create customized cards comprising certain of the patient's health information.

The term “patient” is generally used herein to refer to any person who is, or has ever been, the recipient of health care. The term “health care” is generally used herein to refer to any type of assistance provided to a person that relates to that person's well-being. A “health care provider” can be a person or entity. For example, a health care provider can be a physician, dentist, nurse, pharmacist, family member, friend, hospital administrator, hospital staff, or emergency medical technician. Information related to a patient's health, including, for example, the patient's contact information, age, emergency contact, physicians, dentists, allergies, medications and medical devices, medical history, immunizations, and health insurance, is generally referred to herein as “health information.” A patient's health information can be stored in a database that is accessible via a distributed electronic network, such as the Internet, by the patient and any persons designated by the patient (collectively, “authorized users”).

Turning now to the drawings, in which like numerals indicate like elements throughout the several figures, exemplary embodiments of the invention are described in detail.

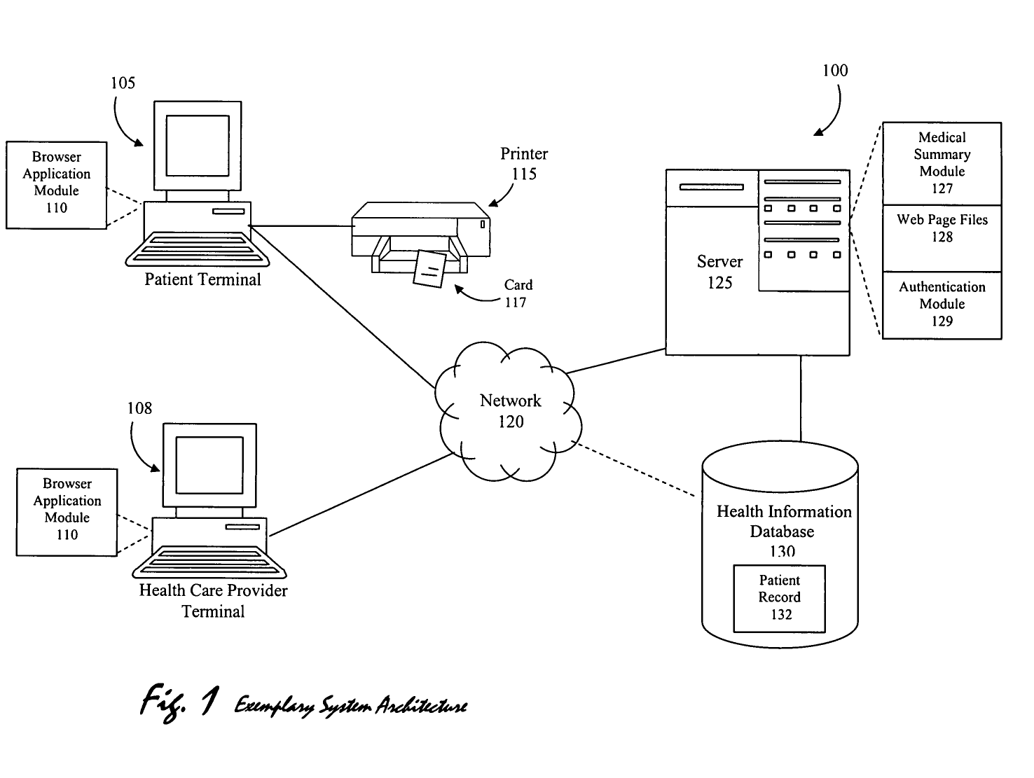

FIG. 1 is a block diagram illustrating an exemplary operating environment 100 for implementation of various embodiments of the present invention. Network devices can be interconnected via a network 120. The network 120 can comprise a wired or wireless telecommunication means by which network devices can exchange data, including for example, a local area network (“LAN”), a wide area network (“WAN”), an intranet, an Internet, or any combination thereof. Throughout the discussion of exemplary embodiments of the present invention, it should be understood that the terms “data” and “information” are used interchangeably herein to refer to text, images, audio, video, or any other form of information that can exist in a computer-based environment.

A network device can be any device capable of transmitting and receiving data over the network 120. For example, a network device can be a server 125, a patient terminal 105, a health care provider terminal 108, or a dedicated storage device, such as a health information database 130. The server 125 can comprise software for interacting, via the network 120 and/or a direct data link, with the health information database 130 and other network devices. A medical summary module 127 of the server 125 can mange the storage, retrieval, and organization of data in the health information database 130. The medical summary module 127 can also publish a network based application comprising data from web page files 128 through which authorized users' network devices, including for example the patient terminal 105 and/or the health care provider terminal 108, can access, update, and/or revise the data.

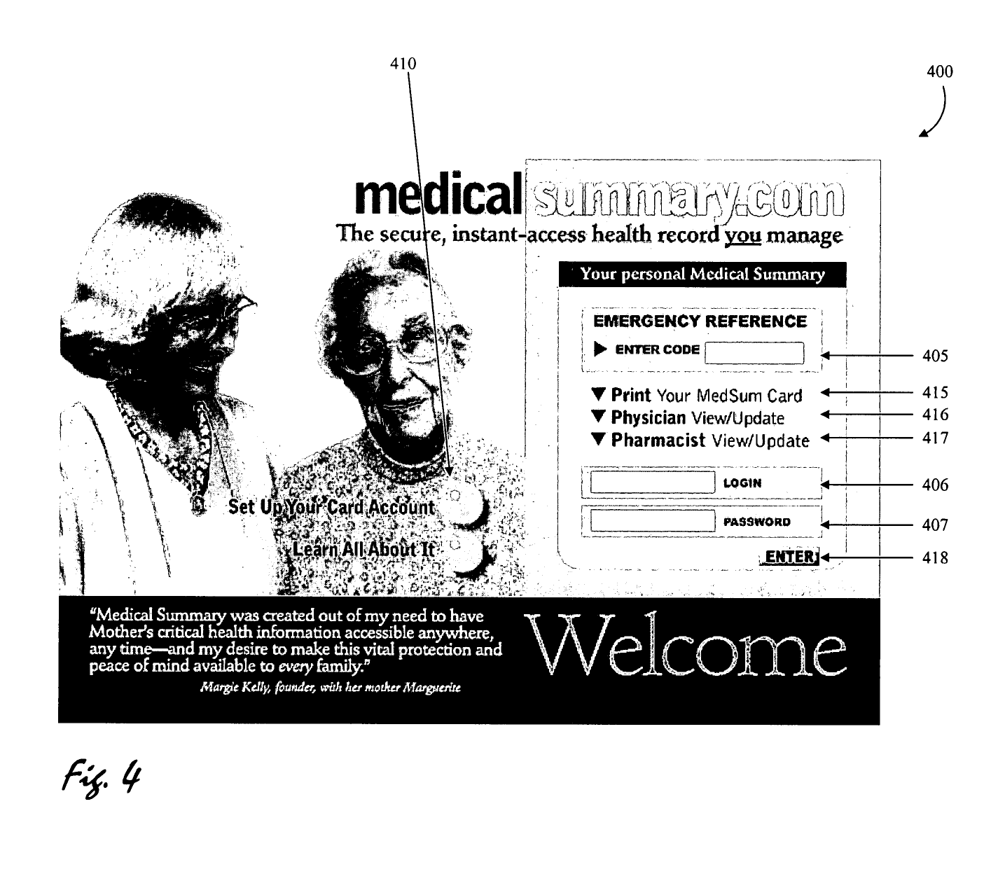

Each patient terminal 105 and health care provider terminal 108 can be a desktop computer, a laptop computer, a wireless network device, such as a personal digital assistant (“PDA”), a handheld computer, or any other wired or wireless, processor-driven device. Each terminal 105, 108 can execute a browser application module 110, such as Microsoft Internet Explorer, Firefox, Netscape, or another suitable application for interacting with web page files 128 maintained by the server 125 and/or other network devices. The web page files 128 can comprise text, graphic, images, sound, video, and other multimedia or data files, that can be transmitted via the network 120. For example, the web page files 128 can comprise one or more files in the HyperText Markup Language (HTML). The browser application module 110 can receive web page files 128 from the server 125 and display to a user a network based application comprising web pages, such as those illustrated in FIGS. 4 and 6-14. The web pages comprise information from the web page files 128.

A web page can comprise one or more input fields in which a user can enter information. The browser application module 110 can transmit that entered information to the server 125 and/or another network device via the network 120. Through one or more such web pages, a patient, or an authorized agent of the patient, can interact with the medical summary module 127 to create a patient record 132. The patient record 132 can comprise information about the patient, including for example, the patient's health information. The patient record 132 can be stored in any suitable data structure. In one embodiment of the present invention, the information in the patient record 132 can be encrypted, e.g., by the patient terminal 105 and/or the medical summary module 127, to prevent unauthorized users from accessing the information. The medical summary module 127 can store the patient record 132 in the health information database 130.

The server 125 and/or the health information database 130 can be maintained by a service provider. The service provider can charge a fee to store, maintain, access, update, and/or revise information in a patient record 132. The fee can be charged to patients and/or other authorized users. To encourage participation, the service provider can provide a commission or referral fee to certain authorized users. For example, the service provider can provide a commission or referral fee to a health care provider for each of his patients that signs up for the service and creates a patient record 132.

Upon creating a patient record 132, a patient can create, or be assigned, e.g., by an authentication module 129 of the server 125, one or more access code, login, and/or password for accessing the information in the patient record 132. Each access code, login, and/or password can comprise a set of numbers, letters, symbols, or combination thereof. For example, an access code can comprise an emergency reference code for use in a medical emergency situation. The emergency reference code could be used, for example, only to view, and not to update and/or revise, information in a patient's patient record 132. The emergency reference code is described in greater detail below, in conjunction with FIG. 4. When supplied by a user, the authentication module 129 can use the patient's access code(s), login(s), and/or password(s) to authenticate the patient's identity and thus to prevent unauthorized persons from accessing the patient record 132. Alternative means for authenticating the patient's identity and/or preventing unauthorized access to the patient record 132 will be apparent to persons of skill in the art.

In certain embodiments of the present invention, the patient can authorize other persons or entities to access, update, and/or revise the information in the patient record 132. For example, the patient can provide his access code(s), login(s), and/or password(s) to his health care provider. Via the health care provider terminal 108, the health care provider can use the patient's access code(s), login(s), and/or password(s) to access, update, and/or revise the patient's health information in the patient record 132. The patient and all other persons authorized to access and/or update the information in the patient record 132 are each referred to herein as an “authorized user.”

In one embodiment of the present invention, each authorized user can create or be assigned, e.g., by the authentication module 129 and/or the patient or another authorized user, their own access code(s), login(s), and/or password(s). The patient can associate each authorized user's access code(s), login(s), and/or password(s) with a different type and/or amount of information in the patient record 132. For example, the patient can limit the types of information that are accessible by authorized users having particular access codes. The patient can also associate read-write permissions with certain access codes, logins, and/or passwords. For example, the patient can allow certain authorized users only to view, and not to edit, some or all of the information in the patient record 132. The authentication module 129 can store information regarding each authorized user's access code(s), login(s), and/or password(s), and read-write permissions (“access information”) in the health information database 130.

To access, update, and/or revise information in the patient record 132, an authorized user can submit access information to the authentication module 129 via web pages displayed by the browser application module 110. The authentication module 129 and/or the user's network device can authenticate the user, e.g., by comparing the access information submitted by the authorized user to the access information previously stored in the health information database 130. If the authentication is successful, the medical summary module 127 can query the patient record 132 to provide the authorized user with certain of the information contained therein. Depending on the access information, as stated above, the types and amounts of provided health information can vary from authorized user to authorized user. Methods for filtering/parsing the information in the patient record 132 based on access information are well known to those of ordinary skill in the art.

As stated above, the data in the patient record 132 can be encrypted. If so, prior to transmitting the data to the authorized user, the medical summary module 127, or another suitable program module of the server 125 or another network device, can decrypt the data. Once the data is decrypted, the medical summary module 127 can transmit it to the authorized user via a previously established, or a new, connection. The connection can comprise a secure connection between the authorized user and the server 125. The connection can be secured, for example, by using a secure transmission protocol, such as the Secure Sockets Layer (SSL) protocol. Other methods for securing a connection over the network 120, including without limitation the use of a firewall, will be apparent to those of ordinary skill in the art.

In certain embodiments of the present invention, a patient can create a customized card 117 comprising certain of the information in the patient record 132. Through web pages displayed by the browser application module 110, the patient can select the types and amounts of information to include on the customized card 117. In one embodiment, the patient can also select the layout, language, and formatting of the customized card 117. Once the patient finishes entering all of his preferences for the customized card, 117, the medical summary module 127 can access the patient record 132 to create a virtual customized card 117. The virtual customized card can be viewable by the patient via the browser application module 110. The patient can save that virtual customized card 125 and/or the patient's preferences for the customized card 117 in the health information database 130.

In one embodiment of the present invention, the health information database 130 can comprise pre-set designations for, e.g., the types and amounts of information to include on the customized card 117, the layout of the card 117, language to use on the card 117, and/or the formatting to use on the card 117. In such an embodiment, even if a patient has not yet created a customized card 117, the medical summary module 127 can still create a customized card 117 comprising information from the patient's patient record 132.

The patient can also produce a hard copy of the customized card 117, for example, by printing the customized card 117 onto paper using a printer 115. Once the customized card 117 is printed, the patient can use the customized card 117 to quickly review his health information and to efficiently communicate that information to others. For example, the patient can communicate certain of his health information to his health care provider simply by handing his customized card to the health care provider. When a patient is suffering from a medical emergency, others can access the patient's customized card 117 to immediately learn important information about the patient, such as the patient's name, emergency contact, allergies, current medications, and medical history, which can be used in treating the patient. If desired, the patient can laminate the customized card 117 to protect it from wear-and-tear. The patient can also magnetize the customized card 117, e.g., by using magnetic printing paper or by placing the customized card 117 into a container having a magnet attached thereto, so that it can be stored on a magnetic surface, such as a refrigerator door.

In one embodiment of the present invention, the patient can instruct the server 125 to allow other authorized users to create customized cards 117. Persons skilled in the art will appreciate that the exemplary architecture 100 illustrated in FIG. 1 is merely representative of the components that can be used for monitoring and communicating health information, and that the present invention can be implemented in other system configurations.

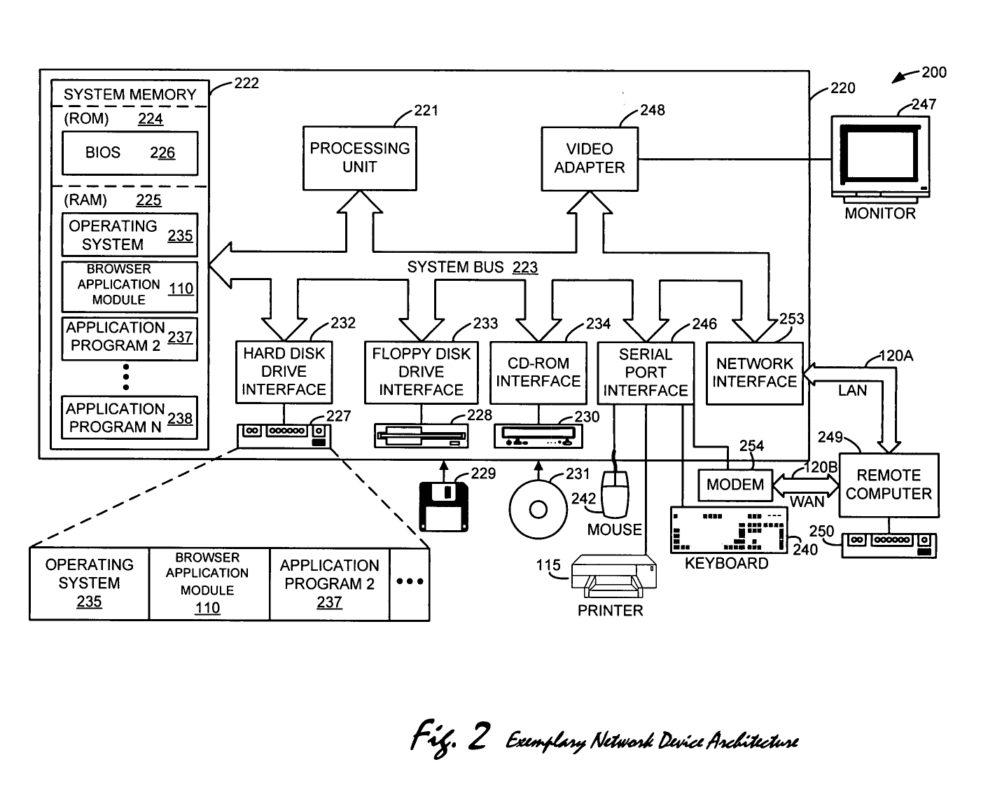

Referring now to FIG. 2, a block diagram is shown that illustrates a general component architecture for a network device 200 constructed in accordance with an exemplary embodiment of the present invention. The exemplary network device 200 comprises a general-purpose computing device in the form of a conventional personal computer 220. Generally, the personal computer 220 comprises a processing unit 221, a system memory 222, and a system bus 223 that couples various system components, including the system memory 222, to the processing unit 221. The system bus 223 can comprise any of several types of bus structures, including a memory bus or memory controller, a peripheral bus, or a local bus, using any of a variety of bus architectures. The system memory 222 comprises a read-only memory (ROM) 224 and a random access memory (RAM) 225. A basic input/output system (BIOS) 226 containing the basic routines that help to transfer information between elements within the personal computer 220, such as during start-up, is stored in the ROM 224.

The personal computer 220 further comprises a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary network device 200 employs a ROM 224, a RAM 225, a hard disk drive 227, a removable magnetic disk 229, and a removable optical disk 231, it should be appreciated by those skilled in the art that other types of computer readable media which can store data that is accessible by a computer can also be used in the exemplary network device 200, such as magnetic cassettes, flash memory cards, digital video disks, Bernoulli cartridges, and the like. The drives and their associated computer readable media can provide nonvolatile storage of computer-executable instructions, data structures, program modules, and other data for the personal computer 220. Program modules comprise computer-executable instructions for causing a processing unit 221 to perform certain tasks.

A number of program modules can be stored on the ROM 224, RAM 225, hard disk drive 227, magnetic disk 229, or optical disk 231, including an operating system 235 and various application modules 110, 237-238. Application modules 110, 237-238 can include routines, sub-routines, programs, objects, components, data structures, etc., which perform particular tasks or implement particular abstract data types. In accordance with an exemplary embodiment of the present invention, the application modules 110, 237-238 can include a browser application module 110. The browser application module 110 can comprise a program module(s) that can be used to interface a user to data. For example, the browser application module 110 can comprise a web browser program through which a user can interact with web page files 128.

A user can enter commands and information to the personal computer 220 through input devices, such as a keyboard 240 and a pointing device 242. The pointing device 242 can comprise a mouse, a trackball, or an electronic pen that can be used in conjunction with an electronic tablet. Other input devices (not shown) can comprise a microphone, joystick, game pad, satellite dish, scanner, or the like. These and other input devices are often connected to the processing unit 222 through a serial port interface 246 that is coupled to the system bus 223, but can be connected by other interfaces, such as a parallel port, game port, a universal serial bus (USB), or the like. A display device 247, such as a monitor, can also be connected to system bus 223 via an interface, such as a video adapter 248. In addition to the display device 247, the personal computer 220 can include other peripheral output devices, such as speakers (not shown) and a printer 115.

The personal computer 220 can operate in a networked environment using logical connections to one or more remote computers 249. The remote computer 249 can be another personal computer, a server, a client, a router, a network PC, a peer device, or other common network node. While the remote computer 249 typically includes many or all of the elements described above relative to the personal computer 220, only a memory storage device 250 has been illustrated in FIG. 2 for simplicity. The logical connections depicted in FIG. 2 include a LAN 120A and a WAN 120B. Such networking environments are commonplace in offices, enterprise-wide computer networks, intranets, and the Internet.

When used in a LAN networking environment, the personal computer 220 is often connected to the LAN 120A through a network interface or adapter 253. When used in a WAN networking environment, the personal computer 220 typically comprises a modem 254 or other means for establishing communications over the WAN 120B, such as the Internet. The modem 254, which can be internal or external, is connected to system bus 223 via a serial port interface 246. In a networked environment, program modules depicted relative to personal computer 220, or portions thereof, can be stored in the remote memory storage device 250. It will be appreciated that the network connections shown are exemplary and other means of establishing a communications link between the computers can be used.

Moreover, those skilled in the art will appreciate that the network device 200 illustrated in FIG. 2 can comprise other suitable computer system configurations.

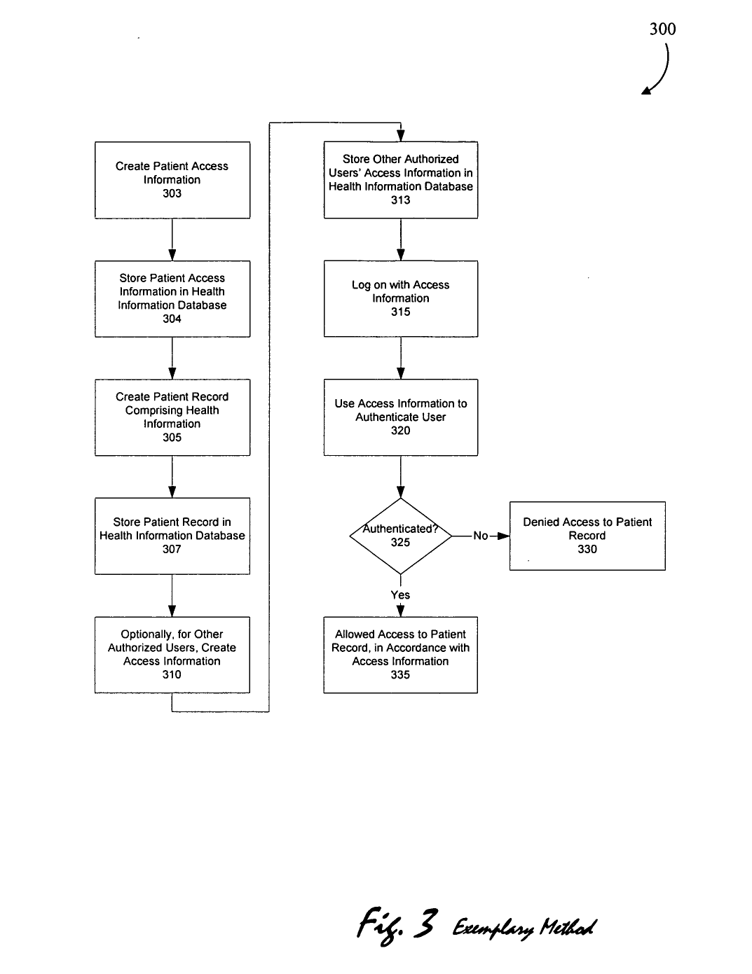

FIG. 3 is a flow chart illustrating steps in a method 300 for maintaining and communicating health information, according to an exemplary embodiment of the present invention. The exemplary method 300 is merely illustrative and, in alternative embodiments of the invention, certain steps can be performed in a different order, certain steps can be omitted entirely, and/or certain additional steps can be performed.

In step 303, patient access information comprising, e.g., the patient's access code(s), login(s), and/or password(s) is created. The patient access information can be created, e.g., by the patient and/or the authentication module 129. The authentication module 129 stores the patient access information in the health information database 130 in step 304. In step 305, the patient (or an agent of the patient) creates a patient record 132. The patient record 132 comprises information about the patient, including for example, the patient's health information. The patient can create the patient record 132, for example, by using the browser application module 110 of the patient terminal 105 to access a network based application comprising web page files 128 through which the patient can enter his information. The web page files 128 can be stored on the server 125 connected to the patient terminal 105 via the network 120. In step 307, the medical summary module 127 stores the patient record in the health information database 130.

In step 310, the patient optionally creates access information for other authorized users. For example, the access information can comprise the access code(s), login(s), password(s), and/or access privileges for each other authorized user. The particular access code(s), login(s), password(s), and/or access privileges for each other authorized user can be assigned by the patient or another authorized user and/or the authentication module 129. The access privileges can comprise information regarding the types and amounts of information each authorized user can access, update, and/or revise, including for example, whether each user is authorized to create a customized card 117. In step 313, the authentication module 129 stores the access information in the health information database 130.

In step 315, a user attempts to log in to the network based application with certain access information. For example, the user can enter his access information in an input field of a web page file 128 displayed on a network device 200 by a browser application module 110. The authentication module 129 attempts to authenticate the user at step 320. To authenticate the user, for example, the authentication module 129 can compare the inputted access information to the access information stored in step 313. If the authentication module 129 fails to authenticate the user in step 325, the user is not allowed to access the patient record 132 in step 330. If the authentication module 129 succeeds in authenticating the user in step 325, the authorized user is allowed to access the patient record 132 in accordance with the access information in step 335. The medical summary module 127 can control the authorized user's ability to access, update, and/or revise the information in the patient record 132 according to the patient's access privileges contained in the access information.

FIG. 4 is an illustrative welcome page 400 of a system for maintaining and communicating health information, according to an exemplary embodiment of the present invention. The welcome page 400 is merely illustrative and, in alternative embodiments of the invention, certain elements of the welcome page 400 can be altered, certain elements can be omitted entirely, and/or certain additional elements can be included.

The welcome page 400 comprises an exemplary interface through which patients (or authorized agents of the patients) can create patient records 132 and authorized users can gain access to information contained within the patient records 132. To create a patient record 132, a patient can activate a “Set Up Your Card Account” icon 410. Activation of that icon 410 can trigger the browser application module 110 to open one or more web pages through which the patient can create a patient record 132.

An authorized user can access information in a patient record 132 by entering access information in one or more input fields 405-407. The access information can comprise an emergency reference code, a login (referred to herein as a “user name”), password(s), and/or access privileges. The emergency reference code is a special type of access information that is typically used in an emergency situation. For example, when a patient is suffering from a medical emergency, others can enter the emergency reference code into the emergency reference code input field 405 to gain access to certain information in the patient's patient record 132. The patient can associate the emergency reference code with certain types and amounts of information in the patient record 132 that would be helpful in a medical emergency. For example, the patient can associate the emergency reference code with information regarding the patient's name, emergency contacts, allergies, current medications, and medical history. The medical summary module 127 can prevent an authorized user from accessing, updating, or revising information that is not associated with the authorized user's access code, login, password(s), and/or access privileges.

Access information can be submitted for authentication, e.g., by activating one of four icons 415-418 or by hitting “Enter” on the user's keyboard 240. For example, if an authorized user desires to print a customized card 117 comprising certain of a patient's health information, the authorized user can submit his access information for authentication by activating the “Print Your MedSum Card” icon 415. Alternatively, if the authorized user is a physician or a pharmacist who desires to view and/or update the information in a patient record 132, the physician/pharmacist can submit his access information for authentication by activating either the “Physician View/Update” icon 416 (for the physician) or the “Pharmacist View/Update” icon 417 (for the pharmacist). In addition, any authorized user can enter access information into one or more of the input fields 405-407 and submit the access information for authentication by activating the “ENTER” icon 418. Authentication of the access information can be performed by the authentication module 129 or locally on the user's network device 200. Other methods for submitting access information for authentication will be apparent to persons of skill in the art.

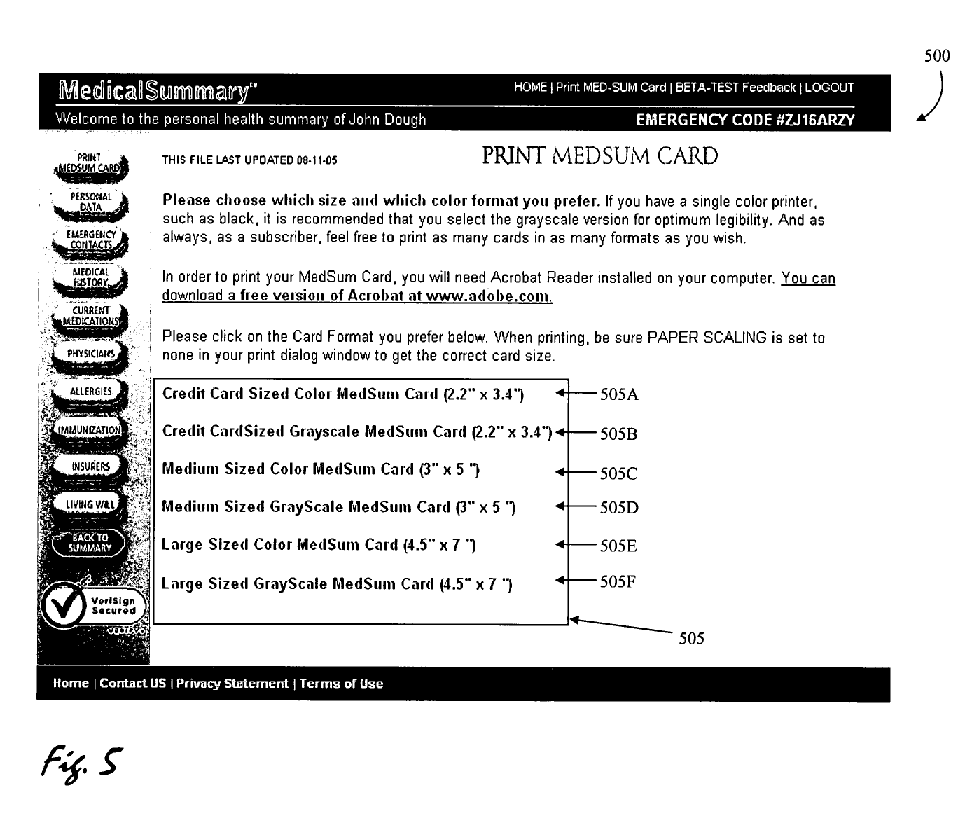

FIG. 5 is an illustrative print customized card page 500 of a system for maintaining and communicating health information, according to an exemplary embodiment of the present invention. The print customized card page 500 is merely illustrative and, in alternative embodiments of the invention, certain elements of the print customized card page 500 can be altered, certain elements can be omitted entirely, and/or certain additional elements can be included.

The print customized card page 500 comprises an exemplary interface through which authorized users, upon successful authentication, can print a customized card 117. The print customized card page 500 presents the authorized users with a variety of formatting options, e.g., sizing and color options, for the customized card 117. To print the customized card 117, an authorized user can activate any of six card format icons 505. For example, to print a credit card sized customized card 117 in full color, the authorized user can active the “Credit Card Sized Color MedSum Card (2.2″×3.4″)” icon 505A. Upon activation of any of the card format icons 505, the medical summary module 127 can create a virtual copy of the customized card 117 that can be viewed in a “Print Preview” screen. The medical summary module 127 can also create a hard copy of the customized card 117, e.g., by submitting printing instructions to the user's printer 115.

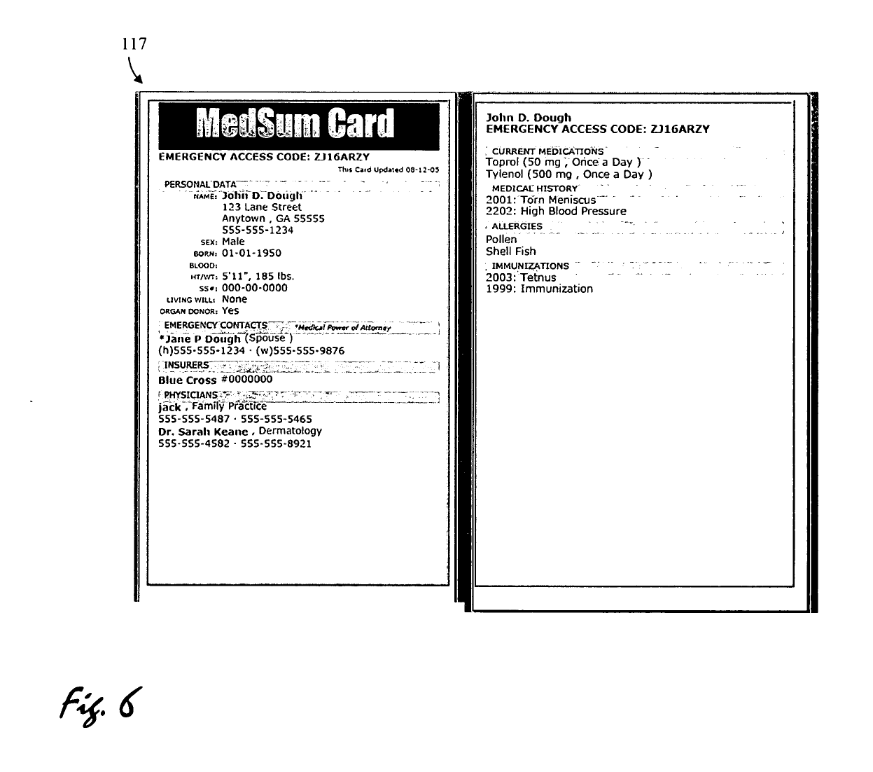

FIG. 6 illustrates a customized card 117 comprising certain of a patient's health information, according to an exemplary embodiment of the present invention. The customized card 117 is merely illustrative and, in alternative embodiments of the invention, certain elements of the customized card 117 can be altered, certain elements can be omitted entirely, and/or certain additional elements can be included. The customized card 117 can be presented to an authorized user upon successful authentication. For example, with reference to FIG. 4, if the user prompted authentication by clicking on the “Print Your MedSum Card” icon 415, the medical summary module 127 can create a virtual copy of the customized card 117 that can be viewed in a “Print Preview” screen. The medical summary module 127 can also create a hard copy of the customized card 117, e.g., by submitting printing instructions to the user's printer 115. With reference to FIG. 5, the customized card 117 can also be presented to an authorized user upon the authorized user's activation of any of the card format icons 505.

In certain embodiments of the present invention, the patient or another authorized user can designate the types and amounts of information to be included on the customized card 117, the layout of the customized card 117, the language of the customized card 117, and/or the formatting of the customized card 117. For example, the customized card 117 can comprise personal data about the patient and information regarding the patient's insurance policy(ies), emergency contacts, physicians, allergies, medical conditions, current medications, medical history, and immunizations.

A patient's personal data can comprise the patient's name, address, telephone number, sex, birth date, blood type, height, weight, social security number, living will instructions (or at least an indication that one exists), and whether the patient is an organ donor. Information regarding the patient's emergency contacts can comprise the contacts' names, telephone numbers, and relationship to the patient, as well as an indication of which emergency contact is the patient's primary emergency contact and an indication of which (if any) of the emergency contacts has the patient's power of attorney. Information regarding the patient's insurance policy(ies) can comprise the insurer's name and the patient's policy number. Information regarding the patient's physicians can comprise the physicians' names and telephone numbers and the types of medicine that they practice. Information regarding the patient's current medications can comprise a list of all the medication names and dosages, including for example the medicine strength and the frequency at which the patient should take the medication. Information regarding the patient's medical history can comprise a list, which can be in chronological order, outlining certain of the patient's medical milestones, including for example, surgeries and certain medical diagnoses. Information regarding the patient's allergies can comprise a list of all of the patient's food, medicinal, or other allergies. Information regarding the patient's immunizations can comprise a list, which can be in chronological order, outlining the types of immunizations and dates on which they were received.

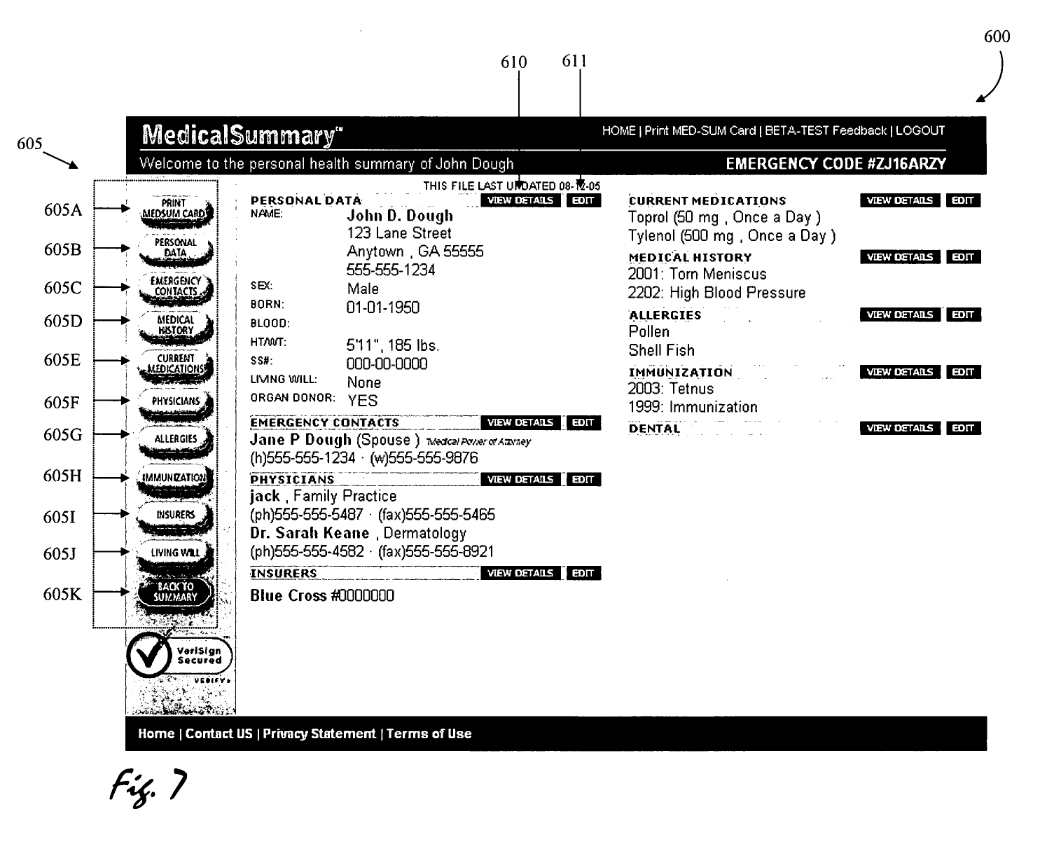

FIG. 7 is an illustrative menu page 600 of a system for maintaining and communicating health information, according to an exemplary embodiment of the present invention. The menu page 600 is merely illustrative and, in alternative embodiments of the invention, certain elements of the menu page 600 can be altered, certain elements can be omitted entirely, and/or certain additional elements can be included. The menu page 600 comprises a menu bar 605 comprising multiple icons 605A-K, the activation of any of which can allow an authorized user to access, update, and/or revise different types of information in the patient's patient record 132. For example, by activating the “PERSONAL DATA” icon 605B, an authorized user can access certain personal data information in the patient record 132.

The menu page 600 can further comprise certain information from the patient record 132, including for example personal data about the patient and information about the patient's insurance policy(ies), emergency contacts, physicians, allergies, medical conditions, current medications, medical history, and immunizations, and multiple icons 610-611, the activation of any of which can allow the user to view more details about the information and/or edit the information. For example, the user can activate the “view details” icon 610 to view more detailed personal data about the patient and the “EDIT” icon 611 to edit the patient's personal data.

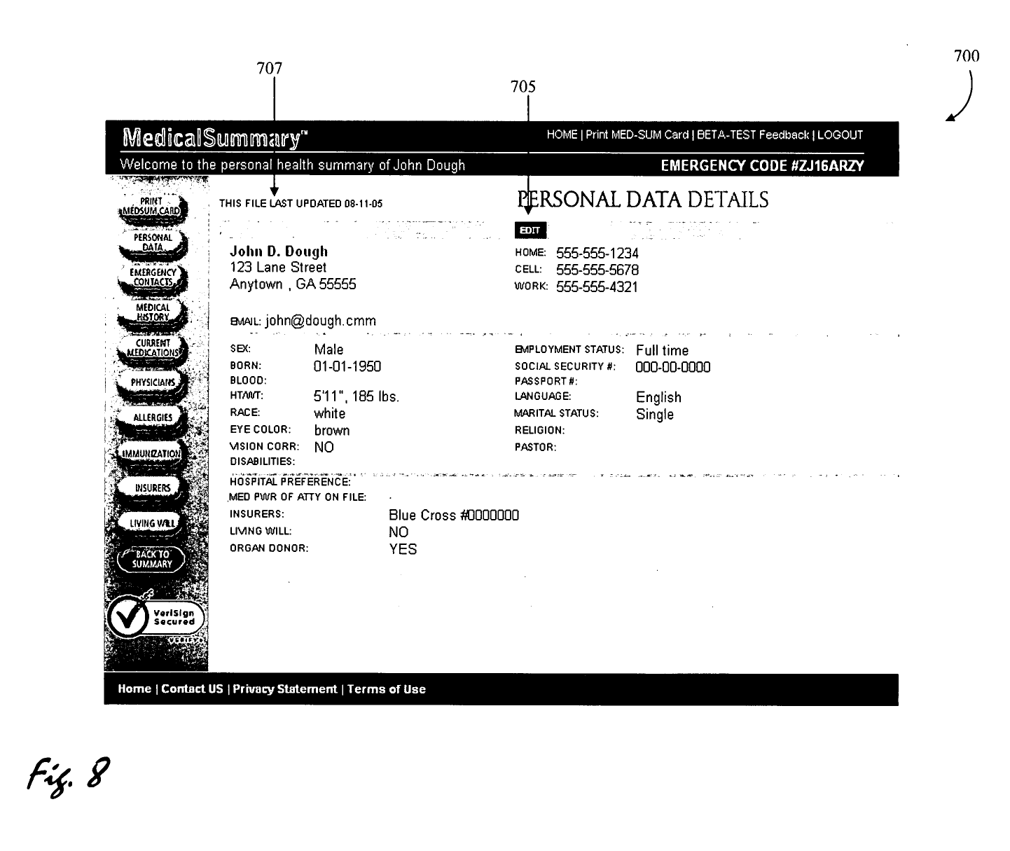

FIG. 8 is an illustrative personal data details page 700 of a system for maintaining and communicating health information, according to an exemplary embodiment of the present invention. The personal data details page 700 is merely illustrative and, in alternative embodiments of the invention, certain elements of the personal data details page 700 can be altered, certain elements can be omitted entirely, and/or certain additional elements can be included. The personal data details page 700 can be presented to the user, e.g., upon activation of the “VIEW DETAILS” icon 610 on the menu page 600 or upon activation of the “PERSONAL DATA” icon 605B.

The personal data details page 700 comprises certain of the patient's personal data, including for example, the patient's name, address, telephone number(s), email address, sex, birth date, blood type, height, weight, race, eye color, employment status, employer's name, employer's contact information, social security number, language(s), marital status, spouse's name and contact information, religious affiliation, religious affiliate's contact information, hospital preference, insurance information, whether the patient wears glasses, contact lens, or otherwise requires vision correction assistance, whether the patient has any disabilities, and if so what they are, contact information for the person(s) holding and/or maintaining the patient's medical power of attorney, and whether the patient is an organ donor. The personal data details page 700 also can comprise information about whether the patient has a living will. If so, the personal data details page 700 can optionally include a link (not shown) to an electronic copy of the living will. The personal data details page 700 can further include a file last updated 707 indicator to inform the authorized user of the date on which the information on the personal data details page 700 was last updated, e.g., by the authorized user or another authorized user.

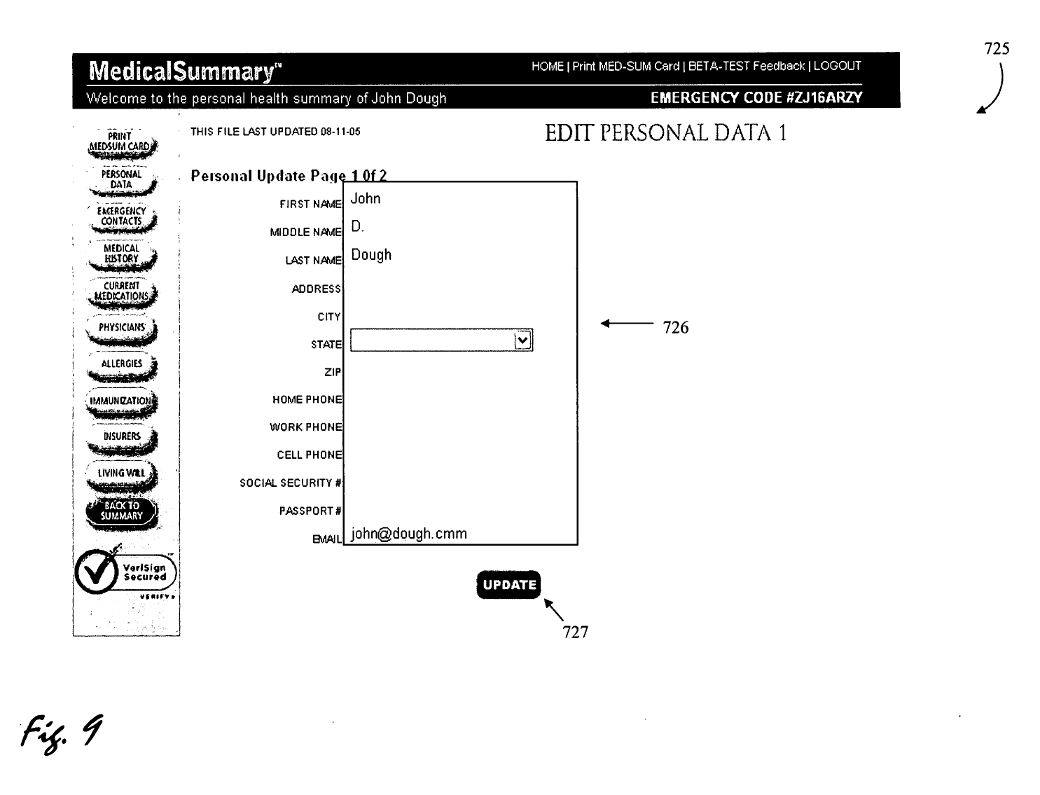

FIG. 9 is an illustrative personal data edit page 1 725 of a system for maintaining and communicating health information, according to an exemplary embodiment of the present invention. The personal data edit page 1 725 is merely illustrative and, in alternative embodiments of the invention, certain elements of the personal data edit page 1 725 can be altered, certain elements can be omitted entirely, and/or certain additional elements can be included. The personal data edit page 1 725 can be presented to the user, e.g., upon activation of the “EDIT” icon 705 on the personal data details page 700.

Through various input fields 726 of the personal data edit page 1 725, an authorized user can update personal information about a patient in the patient record 132. Such personal information can comprise, for example, the patient's first, middle, and last names, the patient's address, city, state, zip code, home phone number, work phone number, cell phone number, social security number, passport number, and email address. Upon entering any updated information into one or more of the input fields 726, the authorized user can submit the information to the medical summary module 127 for storage in the patient record 132 by activating the “UPDATE” icon 727.

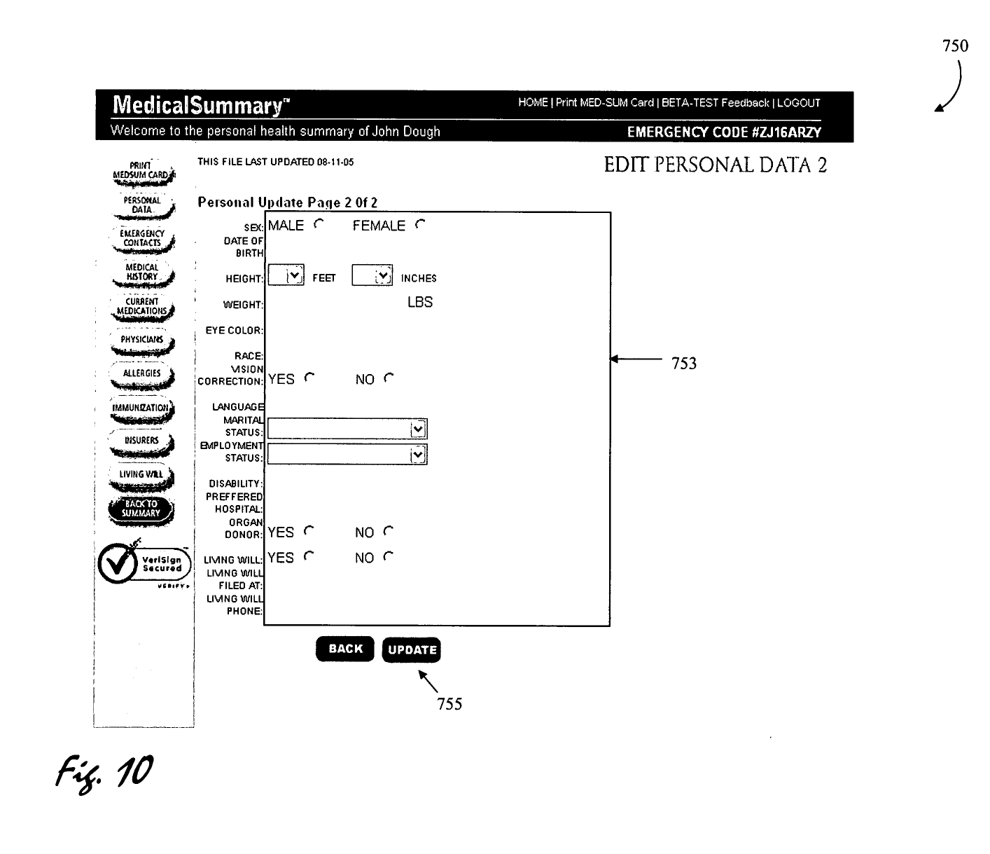

FIG. 10 is an illustrative personal data edit page 2 750 of a system for maintaining and communicating health information, according to an exemplary embodiment of the present invention. The personal data edit page 2 750 is merely illustrative and, in alternative embodiments of the invention, certain elements of the personal data edit page 2 750 can be altered, certain elements can be omitted entirely, and/or certain additional elements can be included. The personal data edit page 2 750 can be presented to the user, e.g., upon activation of the “EDIT” icon 705 on the personal data details page 700.

Through various input fields 753 of the personal data edit page 2 750, an authorized user can update personal information about a patient in the patient record 132. Such personal information can comprise, for example, the patient's sex, date of birth, height, weight, eye color, race, language(s), marital status, employment status, preferred hospital, and whether the patient requires visual correction, whether the patient has a disability, and if so what disability, whether the patient is an organ donor, whether the patient has a living will, and if so, the contact information for the person or entity that has the living will. Upon entering any updated information into one or more of the input fields 753, the authorized user can submit the information to the medical summary module 127 for storage in the patient record 132 by activating the “UPDATE” icon 755.

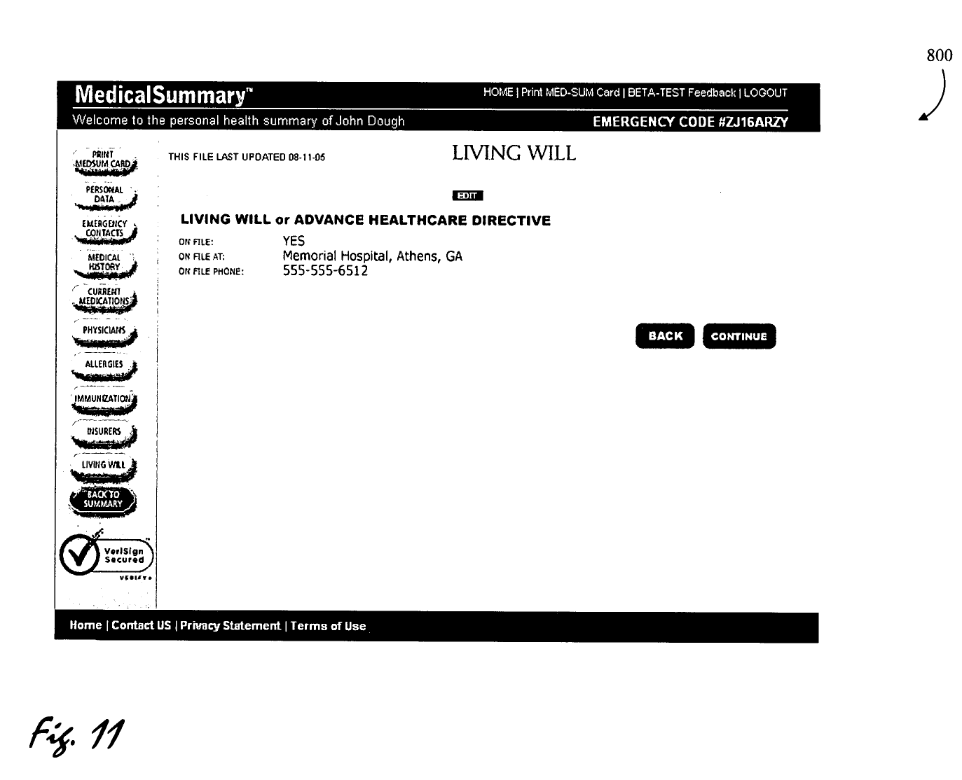

FIG. 11 is an illustrative living will information page 800 of a system for maintaining and communicating health information, according to an exemplary embodiment of the present invention. The living will information page 800 is merely illustrative and, in alternative embodiments of the invention, certain elements of the living will information page 800 can be altered, certain elements can be omitted entirely, and/or certain additional elements can be included. The living will information page 800 can be presented to the user, e.g., upon activation of the “LIVING WILL” icon 605J.

The living will information page 800 comprises information about a patient's living will and/or advanced health care directive, including for example, whether the patient has a living will or advanced health care directive, and if so, who holds the living will/advanced health care directive and where the living will/advanced health care directive is filed. The living will information page 800 can optionally comprise a copy of the patient's living will and/or advanced health care directive.

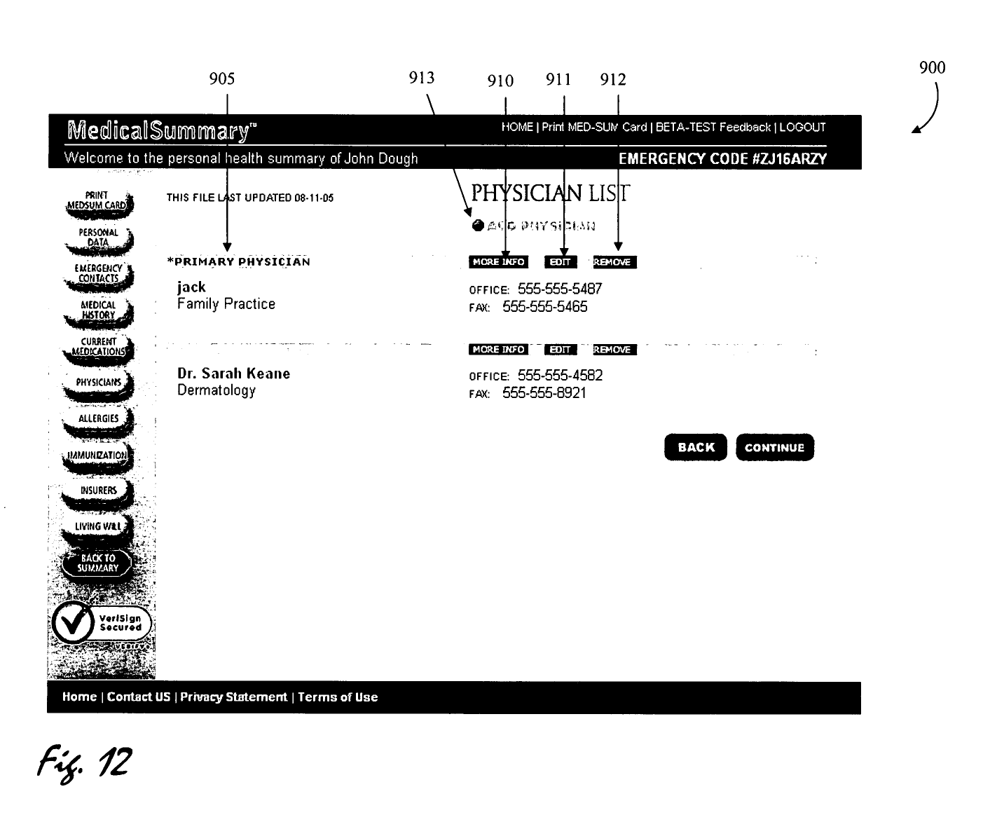

FIG. 12 is an illustrative physicians list page 900 of a system for maintaining and communicating health information, according to an exemplary embodiment of the present invention. The physicians list page 900 is merely illustrative and, in alternative embodiments of the invention, certain elements of the physicians list page 900 can be altered, certain elements can be omitted entirely, and/or certain additional elements can be included. The physicians list page 900 can be presented to the user, e.g., upon activation of the “PHYSICLANS” icon 605F.

The physicians list page 900 comprises certain information regarding the patient's physicians, including for example the physicians' names and telephone numbers and the types of medicine that they practice. The physicians list page 900 can further comprise multiple icons 910-913, the activation of any of which can allow the user to either view more details about a particular physician, edit information regarding a particular physician, remove information about a particular physician, or add a new physician to the list. For example, the user can activate the “MORE INFO” icon 910 to view more detailed information about a particular physician, the “EDIT” icon 911 to edit information regarding a particular physician, the “REMOVE” icon 912 to remove information about a particular physician from the patient record 132, or the “ADD PHYSICIAN” icon 913 to add information about a new physician to the patient record 132. The physicians list page 900 can further comprise a primary physician indicator 905 to indicate which listed physician is the patient's primary physician.

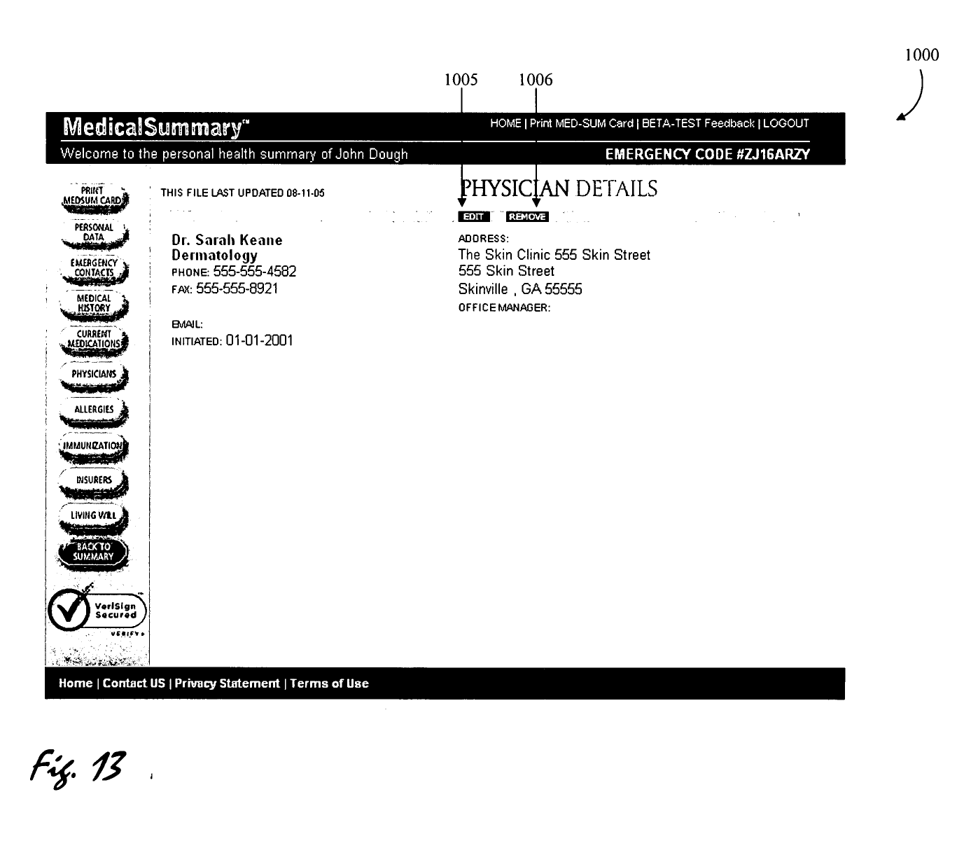

FIG. 13 is an illustrative physicians details page 1000 of a system for maintaining and communicating health information, according to an exemplary embodiment of the present invention. The physicians details page 1000 is merely illustrative and, in alternative embodiments of the invention, certain elements of the physicians details page 1000 can be altered, certain elements can be omitted entirely, and/or certain additional elements can be included. The physicians details page 1000 can be presented to the user, e.g., upon activation of the “MORE INFO” icon 910 on the physicians list page 900 or the “PHYSICLANS” icon 605F.

The physicians details page 1000 comprises certain detailed information regarding the patient's physicians, including for example each physician's name, address, telephone numbers, and email address, the name of the physician's office manager, how long the patient has received health care from the physician, and the types of medicine that the physician practices. The physicians details page 1000 can further comprise multiple icons 1005-1006, the activation of any of which can allow the user to either edit information regarding a particular physician or remove information about a particular physician. For example, the user can activate the “EDIT” icon 1005 to edit information regarding a particular physician, or the “REMOVE” icon 1006 to remove information about a particular physician from the patient record 132.

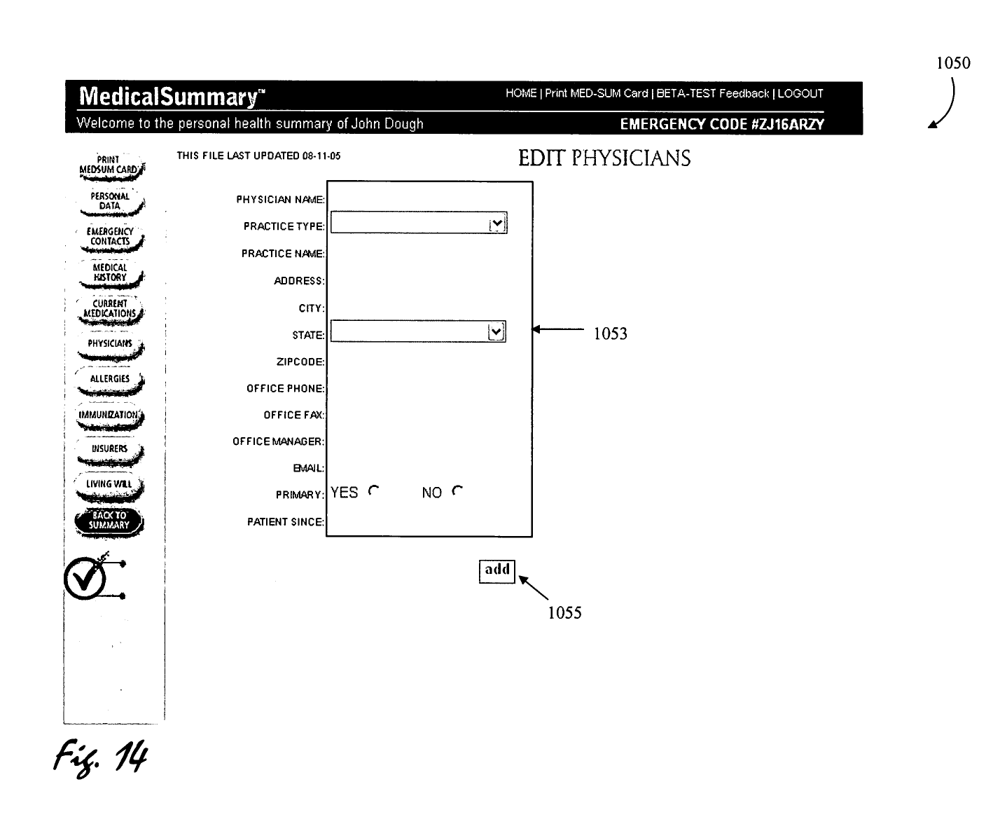

FIG. 14 is an illustrative physicians edit page 1050 of a system for maintaining and communicating health information, according to an exemplary embodiment of the present invention. The physicians edit page 1050 is merely illustrative and, in alternative embodiments of the invention, certain elements of the physicians edit page 1050 can be altered, certain elements can be omitted entirely, and/or certain additional elements can be included. The physicians edit page 1050 can be presented to the user, e.g., upon activation of the “EDIT” icon 911 on the physicians list page 900, upon activation of the “EDIT” icon 1005 on the physicians details page 1000, or upon activation of the “ADD PHSYICLKN” icon 913 on the physicians list page 900.

Through various input fields 1053 on the physicians edit page 1050, an authorized user can update, or enter new, information about a particular physician in the patient record 132. Such information can comprise, for example, the physician's name, practice type, practice name, address, city, state, zip code, office phone number, office fax number, office manager name, email address, and whether the physician is the patient's primary physician, and for how long the patient has been a patient of the physician. Upon entering any updated/new information into one or more of the input fields 1053, the authorized user can submit the information to the medical summary module 127 for storage in the patient record 132 by activating the “ADD” icon 1055.

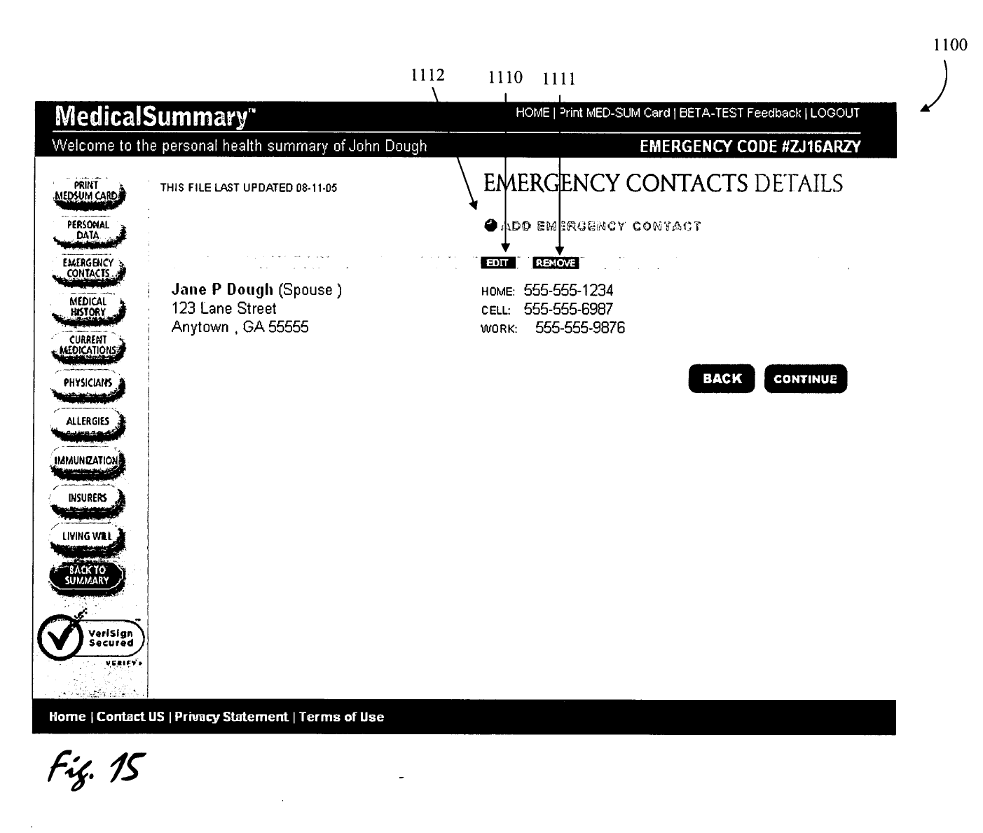

FIG. 15 is an illustrative emergency contacts details page 1100 of a system for maintaining and communicating health information, according to an exemplary embodiment of the present invention. The emergency contacts details page 1100 is merely illustrative and, in alternative embodiments of the invention, certain elements of the emergency contacts details page 1100 can be altered, certain elements can be omitted entirely, and/or certain additional elements can be included. The emergency contacts details page 1100 can be presented to the user, e.g., upon activation of the “EMERGENCY CONTACTS” icon 605C.

The emergency contacts details page 1100 comprises detailed information regarding the patient's emergency contacts, including for example each emergency contact's name, address, telephone numbers, email address, and relationship to the patient. The emergency contacts details page 1100 can further comprise multiple icons 1110-1112, the activation of any of which can allow the user to edit information regarding a particular emergency contact, remove information about a particular emergency contact from the patient record 132, or add information about a new emergency contact to the patient record 132. For example, the user can activate the “EDIT” icon 1110 to edit information regarding a particular emergency contact, the “REMOVE” icon 1111 to remove information about a particular emergency contact from the patient record 132, or the “ADD EMERGENCY CONTACT” icon 1112 to add information about a new emergency contact to the patient record 132. The emergency contacts details page 1100 can further comprise a primary emergency contact indicator (not shown) to indicate which listed emergency contact is the patient's primary emergency contact.

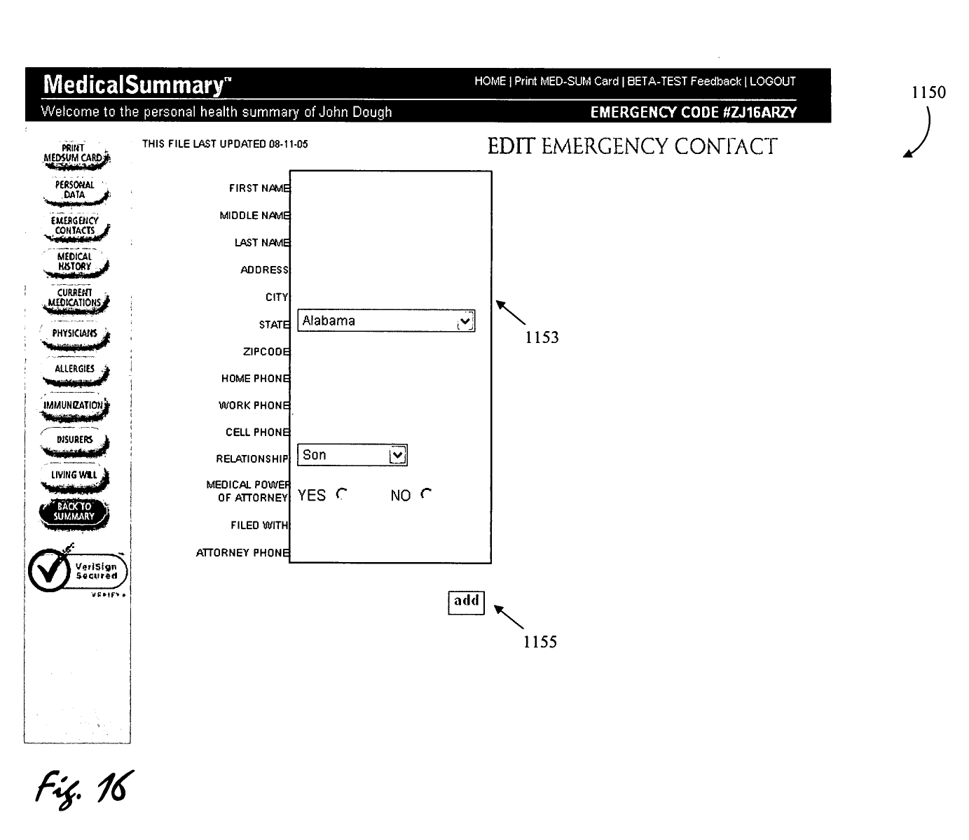

FIG. 16 is an illustrative emergency contacts edit page 1150 of a system for maintaining and communicating health information, according to an exemplary embodiment of the present invention. The emergency contacts edit page 1150 is merely illustrative and, in alternative embodiments of the invention, certain elements of the emergency contacts edit page 1150 can be altered, certain elements can be omitted entirely, and/or certain additional elements can be included. The emergency contacts edit page 1150 can be presented to the user, e.g., upon activation of the “EDIT” icon 1110 on the emergency contacts details page 1100 or upon activation of the “ADD EMERGENCY CONTACT” icon 1112 on the emergency contacts details page 1100.

Through various input fields 1153 of the emergency contacts edit page 1150, an authorized user can update, or enter new, information about a particular emergency contact in the patient record 132. Such information can comprise, for example, the emergency contact's first, middle, and last name, the emergency contact's address, city, state, zip code, home phone number, work phone number, cell phone number, relationship to the patient, and whether the patient has a medical power of attorney, and if so, contact information for the attorney with whom the medical power of attorney is filed. Upon entering any updated/new information into one or more of the input fields 1153, the authorized user can submit the information to the medical summary module 127 for storage in the patient record 132 by activating the “ADD” icon 1155.

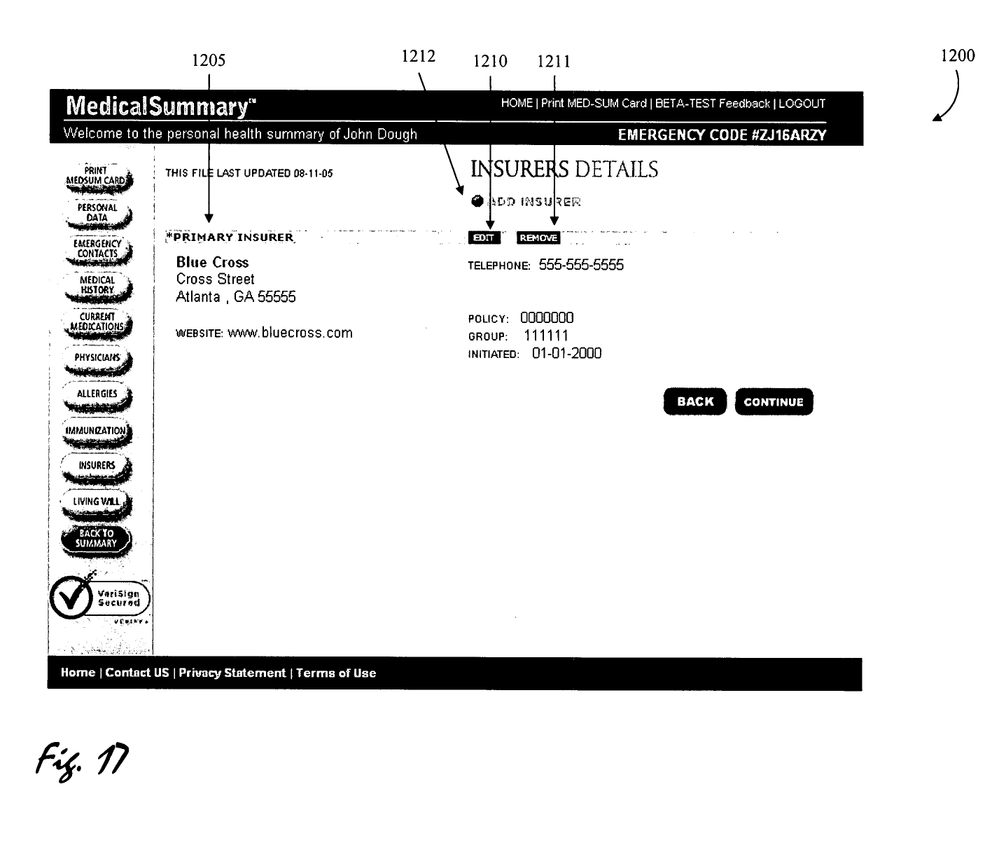

FIG. 17 is an illustrative insurers details page 1200 of a system for maintaining and communicating health information, according to an exemplary embodiment of the present invention. The insurers details page 1200 is merely illustrative and, in alternative embodiments of the invention, certain elements of the insurers details page 1200 can be altered, certain elements can be omitted entirely, and/or certain additional elements can be included. The insurers details page 1200 can be presented to the user, e.g., upon activation of the “INSURERS” icon 6051.

The insurers details page 1200 comprises detailed information regarding the patient's insurance policy(ies), including for example, for each insurance policy, the insurer's name, the insurer's address, the insurer's website address, the insurer's telephone number(s), the policy number, the group number, and the date on which the policy was initiated. The insurers details page 1200 can further comprise multiple icons 1210-1212, the activation of any of which can allow the user to edit information regarding a particular insurer, remove information about a particular insurer from the patient record 132, or add information about a new insurer to the patient record 132. For example, the user can activate the “EDIT” icon 1210 to edit information regarding a particular insurer, the “REMOVE” icon 1211 to remove information about a particular insurer from the patient record 132, or the “ADD INSURER” icon 1212 to add information about a new insurer to the patient record 132. The insurers details page 1200 can further comprise a primary insurer indicator 1205 to indicate which listed insurer is the patient's primary insurer.

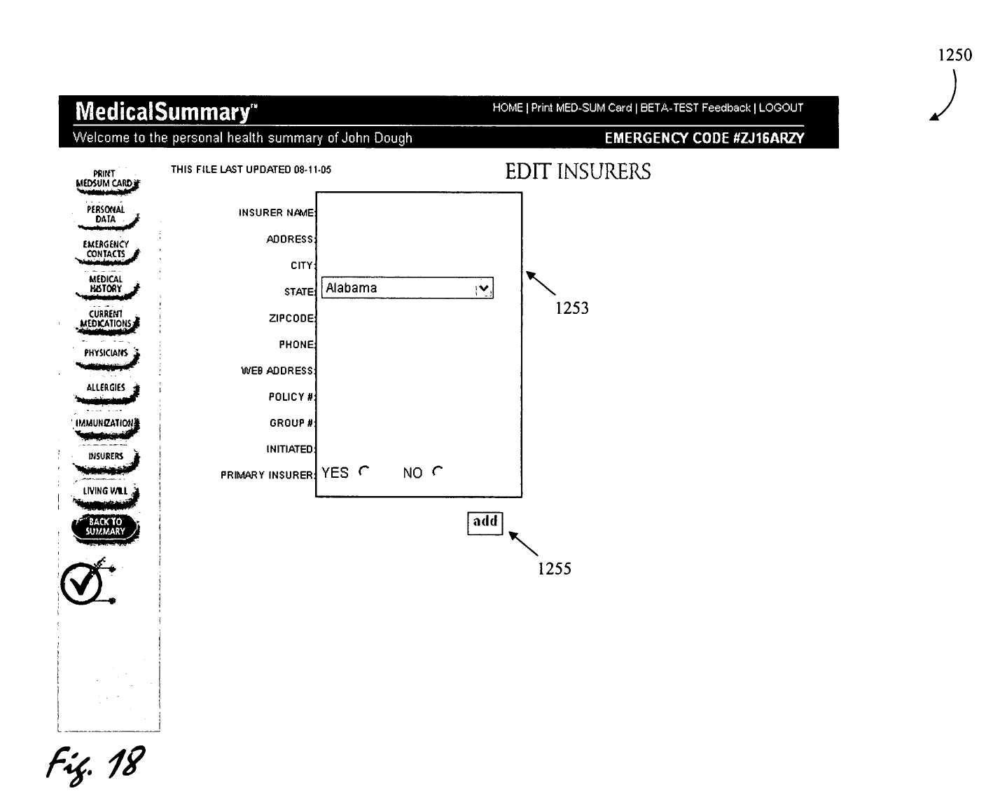

FIG. 18 is an illustrative insurers edit page 1250 of a system for maintaining and communicating health information, according to an exemplary embodiment of the present invention. The insurers edit page 1250 is merely illustrative and, in alternative embodiments of the invention, certain elements of the insurers edit page 1250 can be altered, certain elements can be omitted entirely, and/or certain additional elements can be included. The insurers edit page 1250 can be presented to the user, e.g., upon activation of the “EDIT” icon 1210 on the insurers details page 1200 or upon activation of the “ADD INSURER” icon 1212 on the insurers details page 1200.

Through various input fields 1253 of the insurers edit page 1250, an authorized user can update, or enter new, information about a particular insurer in the patient record 132. Such information can comprise, for example, the insurer's name, address, city, state, zip code, phone number, web address, the patient's insurance policy number, the group number, the date on which the policy was initiated and whether the insurer is the patient's primary insurer. Upon entering any updated/new information into one or more of the input fields 1253, the authorized user can submit the information to the medical summary module 127 for storage in the patient record 132 by activating the “ADD” icon 1255.

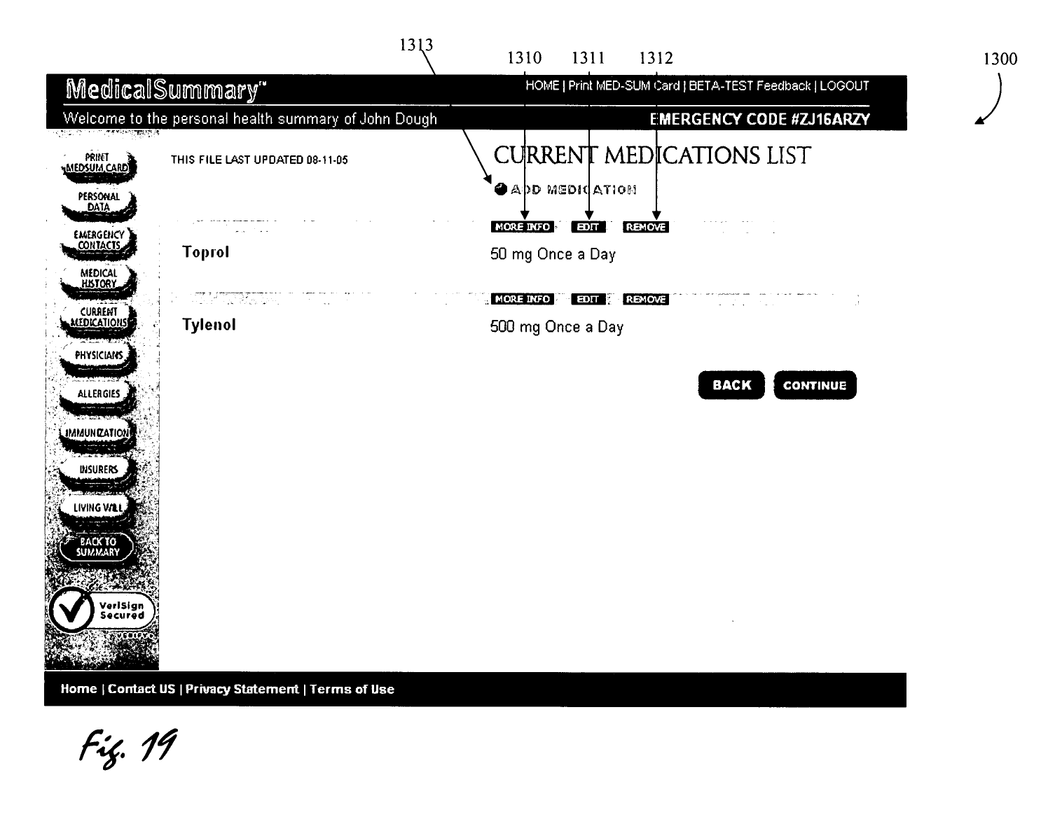

FIG. 19 is an illustrative current medications list page 1300 of a system for maintaining and communicating health information, according to an exemplary embodiment of the present invention. The current medications list page 1300 is merely illustrative and, in alternative embodiments of the invention, certain elements of the current medications list page 1300 can be altered, certain elements can be omitted entirely, and/or certain additional elements can be included. The current medications list page 1300 can be presented to the user, e.g., upon activation of the “current medications” icon 605E.

The current medications list page 1300 comprises certain information regarding the patient's current medications, including for example, each current medication's name and dosage, including the dosage strength of the medicine. The current medications list page 1300 can further comprise multiple icons 1310-1313, the activation of any of which can allow the user to view more details about a particular current medication, edit information regarding a particular current medication, remove information about a current medication from the patient record 132, or add information about a new current medication to the patient record 132. For example, the user can activate the “MORE INFO” icon 1310 to view more detailed information about a particular current medication, the “EDIT” icon 1311 to edit information regarding a particular current medication, the “REMOVE” icon 1312 to remove information about a particular current medication from the patient record 132, or the “ADD MEDICATION” icon 1313 to add information about a new current medication to the patient record 132.

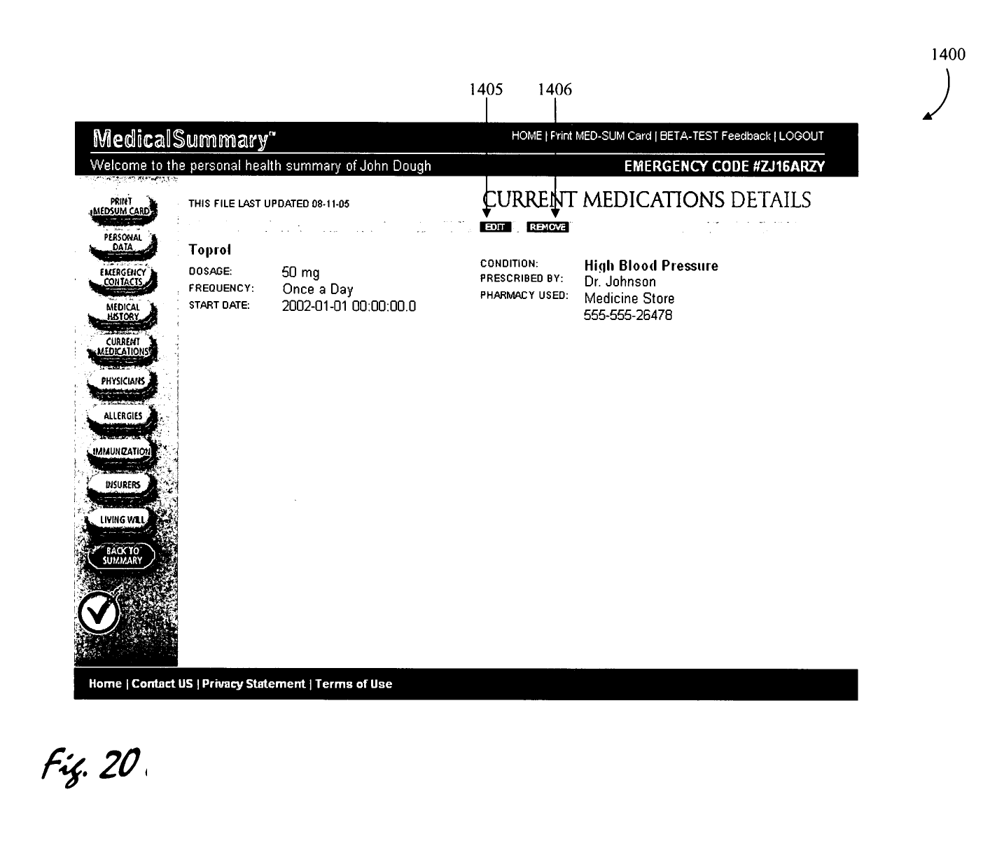

FIG. 20 is an illustrative current medications details page 1400 of a system for maintaining and communicating health information, according to an exemplary embodiment of the present invention. The current medications details page 1400 is merely illustrative and, in alternative embodiments of the invention, certain elements of the current medications details page 1400 can be altered, certain elements can be omitted entirely, and/or certain additional elements can be included. The current medication details page 1400 can be presented to the user, e.g., upon activation of the “MORE INFO” icon 1310 on the current medications list page 1300 or upon activation of the “current medications” icon 605E.

The current medications details page 1400 comprises certain information regarding the patient's current medications, including for example, each current medication's name and dosage, including the dosage strength and the frequency at which the patient is supposed to take the medication, the condition for which the medication was prescribed, the physician that prescribed the medication, and the name and contact information for the pharmacy that provided the patient with the medication. The current medications details page 1400 can further comprise multiple icons 1405-1406, the activation of any of which can allow the user to edit information regarding a particular current medication or remove information about a particular current medication. For example, the user can activate the “EDIT” icon 1405 to edit information regarding a particular current medication or the “REMOVE” icon 1406 to remove information about a particular current medication from the patient record 132.

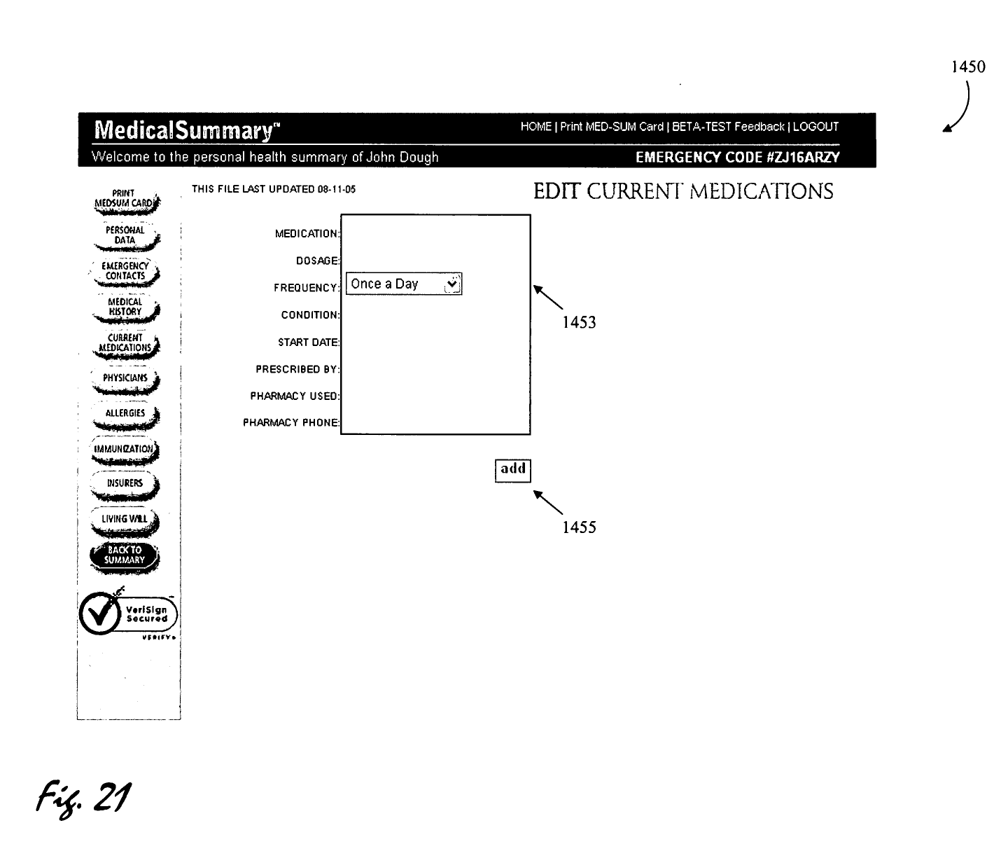

FIG. 21 is an illustrative current medications edit page 1450 of a system for maintaining and communicating health information, according to an exemplary embodiment of the present invention. The current medications edit page 1450 is merely illustrative and, in alternative embodiments of the invention, certain elements of the current medications edit page 1450 can be altered, certain elements can be omitted entirely, and/or certain additional elements can be included. The current medications edit page 1450 can be presented to the user, e.g., upon activation of the “EDIT” icon 1311 on the current medications list page 1300, upon activation of the “EDIT” icon 1405 on the current medications details page 1400, or upon activation of the “ADD CURRENT MEDICATION” icon 1313 on the current medications list page 1300.

Through various input fields 1453 of the current medications edit page 1450, an authorized user can update, or enter new, information about a particular current medications in the patient record 132. Such information can comprise, for example, the medication name, the dosage, the frequency at which the patient should take the medication, the condition for which the medication is taken, the date on which the patient started taking the medication, the name of the physician that prescribed the medication, the pharmacy that fills (or filled or will fill) the prescription for the patient, and the pharmacy's telephone number. Upon entering any updated/new information into one or more of the input fields 1453, the authorized user can submit the information to the medical summary module 127 for storage in the patient record 132 by activating the “ADD” icon 1455.

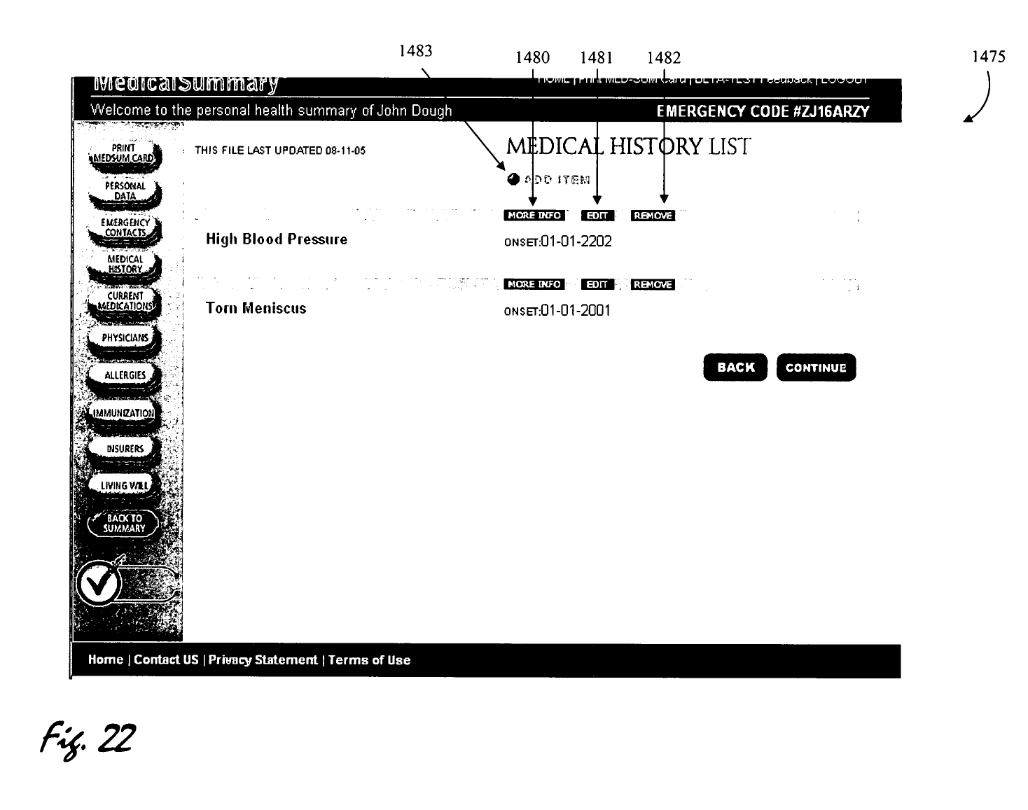

FIG. 22 is an illustrative medical history list page 1475 of a system for maintaining and communicating health information, according to an exemplary embodiment of the present invention. The medical history list page 1475 is merely illustrative and, in alternative embodiments of the invention, certain elements of the medical history list page 1475 can be altered, certain elements can be omitted entirely, and/or certain additional elements can be included. The medical history list page 1475 can be presented to the user, e.g., upon activation of the “MEDICAL HISTORY” icon 605D.

The medical history list page 1475 comprises certain information regarding the patient's medical history, including for example, information regarding certain of the patient's diagnoses, surgeries, and other medical milestones. Information regarding a diagnosis can comprise, for example, the name of the diagnosed disease or ailment, the date on which the diagnosis was made, and the date on which the patient first suffered from the disease/ailment. The medical history list page 1475 can further comprise multiple icons 1480-1483, the activation of any of which can allow the user to view more details about a particular medical milestone, edit information regarding a particular medical milestone, remove information about a particular medical milestone from the patient record 132, or add information about a new medical milestone to the patient record 132. For example, the user can activate the “MORE INFO” icon 1480 to view more detailed information about a particular medical milestone, the “EDIT” icon 1481 to edit information regarding a particular medical milestone, the “REMOVE” icon 1482 to remove information about a particular medical milestone from the patient record 132, or the “ADD ITEM” icon 1483 to add information about a new medical milestone to the patient record 132.

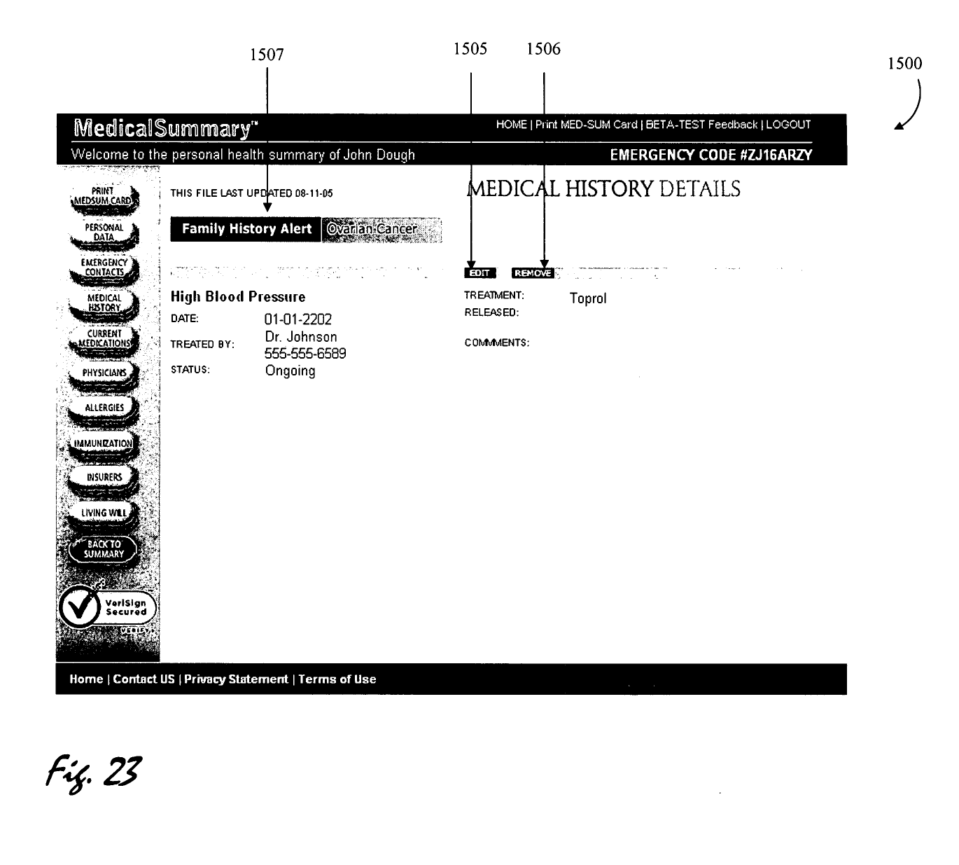

FIG. 23 is an illustrative medical history details page 1500 of a system for maintaining and communicating health information, according to an exemplary embodiment of the present invention. The medical history details page 1500 is merely illustrative and, in alternative embodiments of the invention, certain elements of the medical history details page 1500 can be altered, certain elements can be omitted entirely, and/or certain additional elements can be included. The medical history details page 1500 can be presented to the user, e.g., upon activation of the “MORE INFO” icon 1480 on the medical history list page 1475 or upon activation of the “medical history” icon 605D.

The medical history details page 1500 comprises certain information regarding the patient's medical history, including for example, information regarding certain of the patient's diagnoses, surgeries, and other medical milestones. Information regarding a diagnosis can comprise, for example, the name of the diagnosed disease or ailment, the year in which the diagnosis was made, when the patient first suffered from the disease/ailment, the current status of the disease/ailment, the current treatment for the disease/ailment, and any other comments or information related to the disease/ailment or diagnosis. If the current treatment for the disease/ailment comprises medication, the medical history details page 1500 can further comprise a link (not shown) to a web page comprising information regarding the medication, e.g., the current medications list page 1300 or the current medications details page 1400.

The medical history details page 1500 can further comprise multiple icons 1505-1506, the activation of any of which can allow the user to edit information regarding a particular medical milestone or remove information about a particular medical milestone. For example, the user can activate the “EDIT” icon 1505 to edit information regarding a particular medical milestone or the “REMOVE” icon 1506 to remove information about a particular medical milestone from the patient record 132. The medical history details page 1500 can further comprise a family history alert indicator 1507 to inform the authorized user of any noteworthy family medical history information about the patient. For example, the family history alert indicator 1507 can inform the authorized user of a debilitating medical condition, e.g., ovarian cancer, of which one or more members of the patient's family suffers.

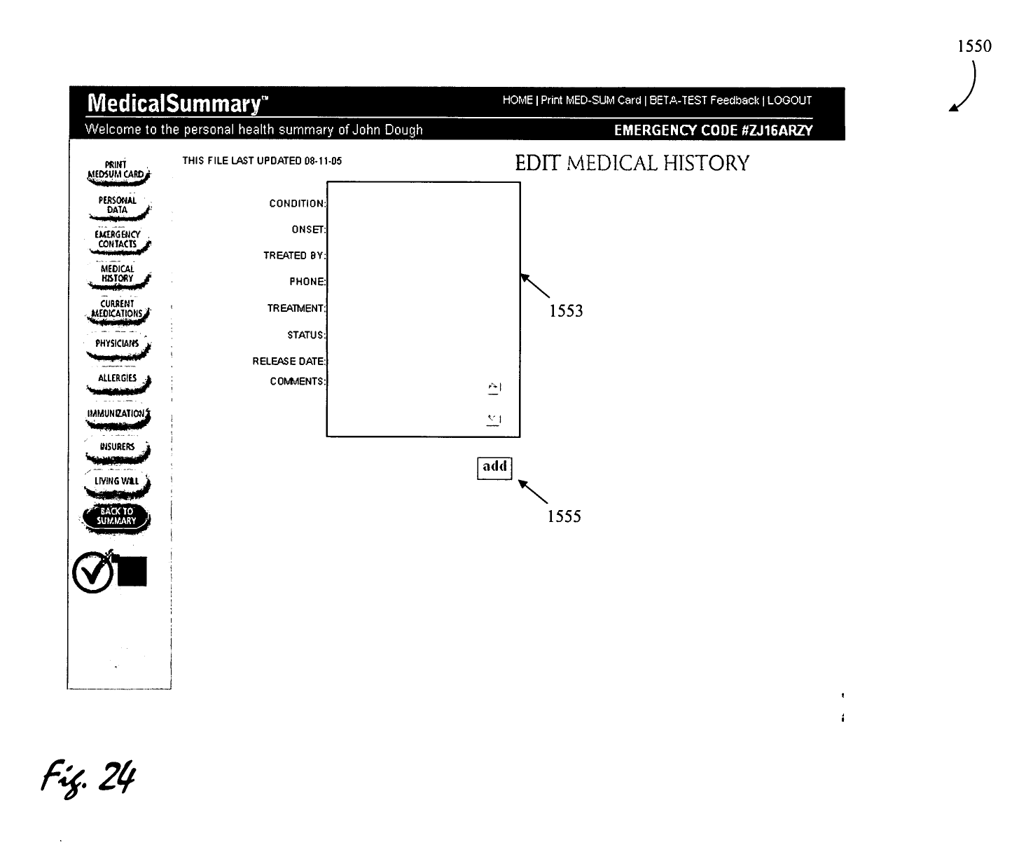

FIG. 24 is an illustrative medical history edit page 1550 of a system for maintaining and communicating health information, according to an exemplary embodiment of the present invention. The medical history edit page 1550 is merely illustrative and, in alternative embodiments of the invention, certain elements of the medical history edit page 1550 can be altered, certain elements can be omitted entirely, and/or certain additional elements can be included. The medical history edit page 1550 can be presented to the user, e.g., upon activation of the “EDIT” icon 1481 on the medical history list page 1475, upon activation of the “EDIT” icon 1505 on the medical history details page 1500, or upon activation of the “ADD ITEM” icon 1483 on the medical history list page 1475.

Through various input fields 1553 of the medical history edit page 1550, an authorized user can update, or enter new, information about a particular medical milestone in the patient record 132. Such information can comprise, for example, the name of a new medical condition, the date on which the patient first suffered from the new condition, the name of the physician treating the condition, the phone number of that physician, the current treatment for the condition, the current status of the treatment, the patient's release date for the condition, and any comments the authorized user desires to submit related to the condition. Upon entering any updated/new information into one or more of the input fields 1553, the authorized user can submit the information to the medical summary module 127 for storage in the patient record 132 by activating the “ADD” icon 1555.

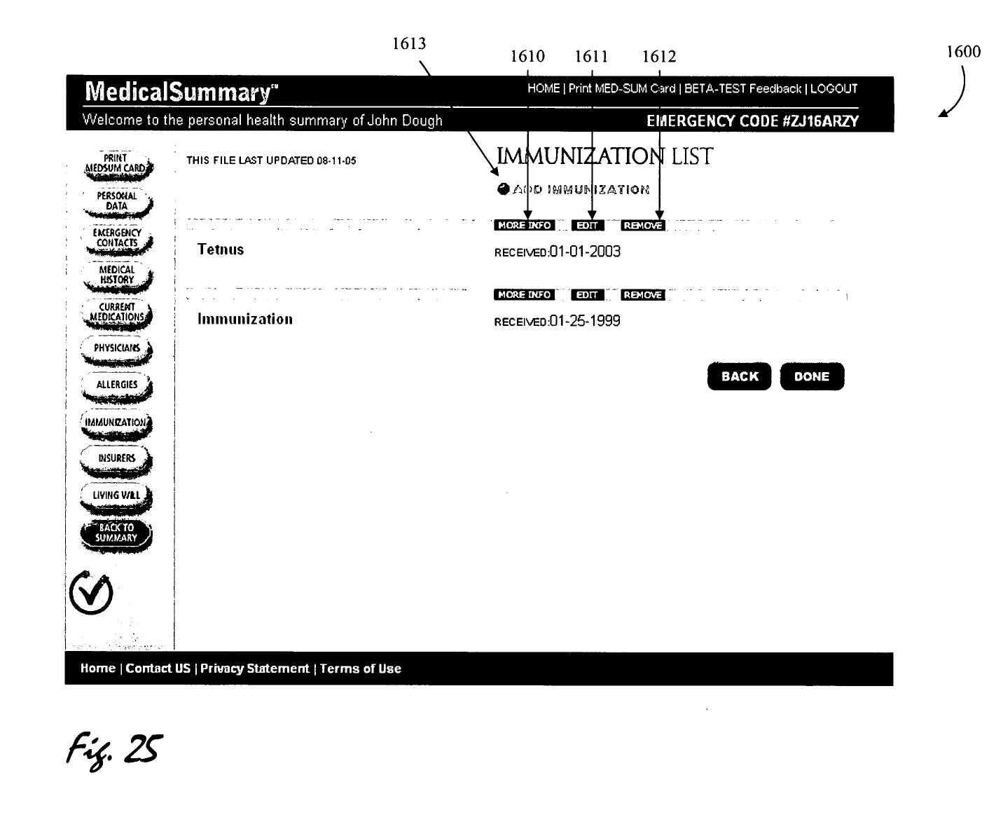

FIG. 25 is an illustrative immunization list page 1600 of a system for maintaining and communicating health information, according to an exemplary embodiment of the present invention. The immunization list page 1600 is merely illustrative and, in alternative embodiments of the invention, certain elements of the immunization list page 1600 can be altered, certain elements can be omitted entirely, and/or certain additional elements can be included. The immunization list page 1600 can be presented to the user, e.g., upon activation of the “IMMUNIZATION” icon 605H.

The immunization list page 1600 comprises certain information regarding the patient's immunizations, including for example, the names of each immunization and the dates on which they were received. The immunization list page 1600 can further comprise multiple icons 1610-1613, the activation of any of which can allow the user to view more details about a particular immunization, edit information regarding a particular immunization, remove information about a particular immunization from the patient record 132, or add information about a new immunization to the patient record 132. For example, the user can activate the “MORE INFO” icon 1610 to view more detailed information about a particular immunization, the “EDIT” icon 1611 to edit information regarding a particular immunization, the “REMOVE” icon 1612 to remove information about a particular immunization from the patient record 132, or the “ADD IMMUNIZATION” icon 1613 to add information about a new immunization to the patient record 132.

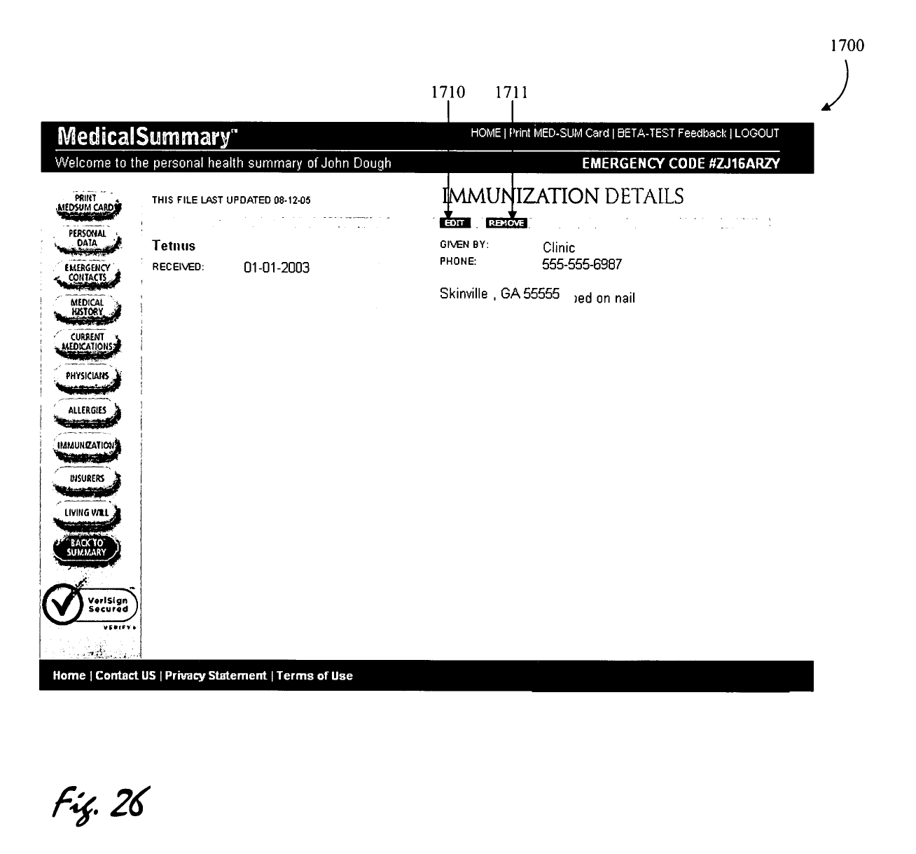

FIG. 26 is an illustrative immunization details page 1700 of a system for maintaining and communicating health information, according to an exemplary embodiment of the present invention. The immunization details page 1700 is merely illustrative and, in alternative embodiments of the invention, certain elements of the immunization details page 1700 can be altered, certain elements can be omitted entirely, and/or certain additional elements can be included. The immunization details page 1700 can be presented to the user, e.g., upon activation of the “MORE INFO” icon 1610 on the immunization list page 1600 or upon activation of the “IMMUIZATION” icon 605H.

The immunization details page 1700 comprises certain information regarding the patient's immunizations, including for example, the names of each immunization, the dates on which the immunizations were received, the names of the physicians that gave the patient the immunization, and any comments an authorized user desires to submit related to the immunization. The immunization details page 1700 can further comprise multiple icons 1710-1711, the activation of any of which can allow the user to edit information regarding a particular immunization or remove information about a particular immunization. For example, the user can activate the “EDIT” icon 1710 to edit information regarding a particular immunization or the “REMOVE” icon 1711 to remove information about a particular immunization from the patient record 132.

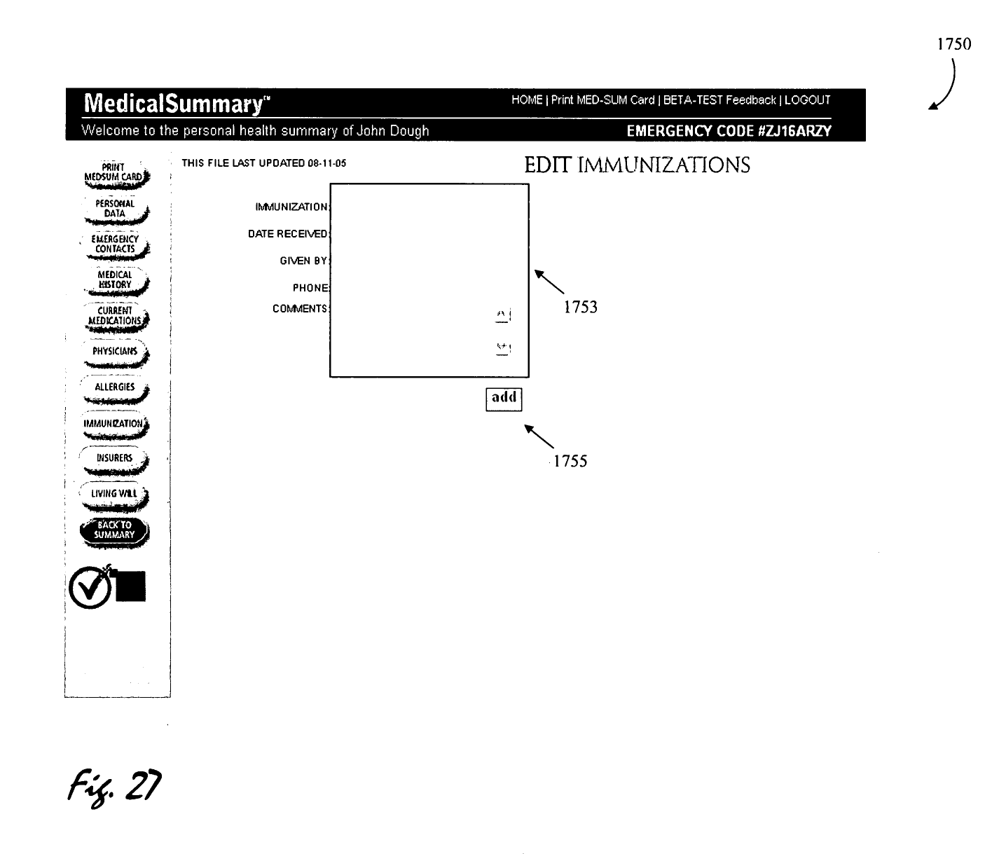

FIG. 27 is an illustrative immunization edit page 1750 of a system for maintaining and communicating health information, according to an exemplary embodiment of the present invention. The immunization edit page 1750 is merely illustrative and, in alternative embodiments of the invention, certain elements of the immunization edit page 1750 can be altered, certain elements can be omitted entirely, and/or certain additional elements can be included. The immunization edit page 1750 can be presented to the user, e.g., upon activation of the “EDIT” icon 1611 on the immunization list page 1600, upon activation of the “EDIT” icon 1710 on the immunization details page 1700, or upon activation of the “ADD IMMUNIZATION” icon 1613 on the immunization list page 1600.

Through various input fields 1753 of the immunization edit page 1750, an authorized user can update, or enter new, information about a particular immunization in the patient record 132. Such information can comprise, for example, the name of the immunization, the date on which it was received, the name and phone number of the physician that gave the patient the immunization, and any comments the authorized user wishes to enter related to the immunization. Upon entering any updated/new information into one or more of the input fields 1753, the authorized user can submit the information to the medical summary module 127 for storage in the patient record 132 by activating the “ADD” icon 1755.

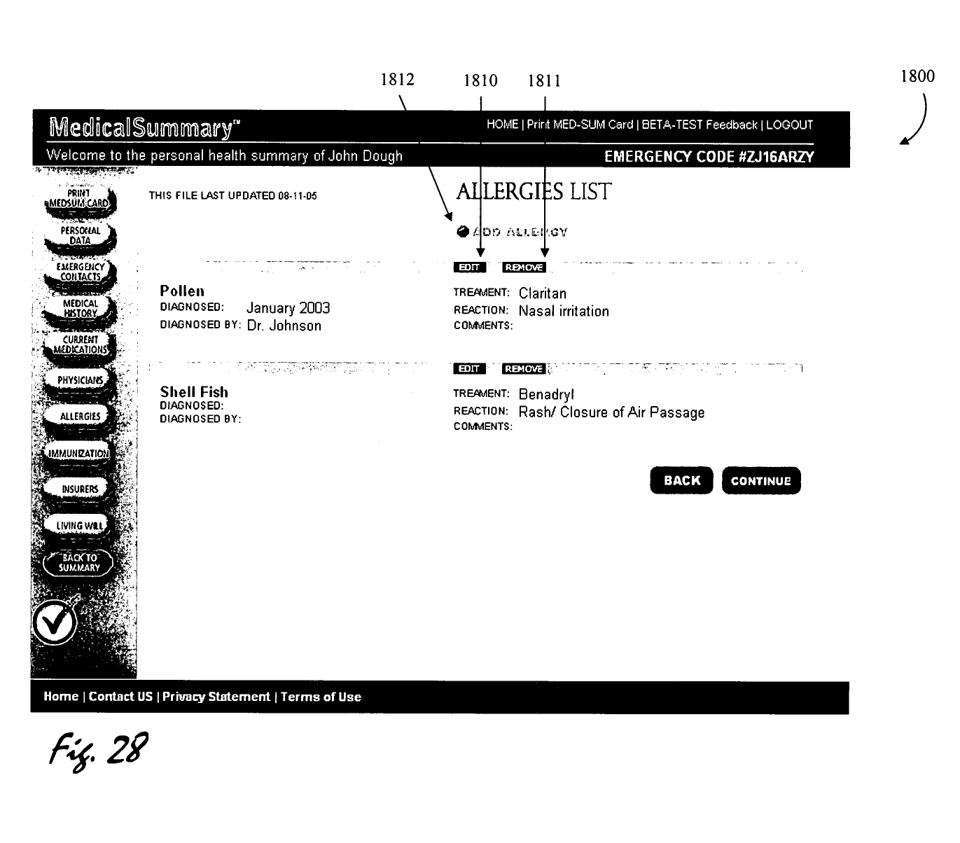

FIG. 28 is an illustrative allergies list page 1800 of a system for maintaining and communicating health information, according to an exemplary embodiment of the present invention. The allergies list page 1800 is merely illustrative and, in alternative embodiments of the invention, certain elements of the allergies list page 1800 can be altered, certain elements can be omitted entirely, and/or certain additional elements can be included. The allergies list page 1800 can be presented to the user, e.g., upon activation of the “ALLERGIES” icon 605G.

The allergies list page 1800 comprises certain information regarding the patient's allergies, including for example, for each allergy, the name of the allergy, the date on which it was diagnosed, the name of the physician that diagnosed the allergy, the treatment for the allergy, the patient's reaction to the allergen, and any comments submitted by an authorized user related to the allergy. The allergies list page 1800 can further comprise multiple icons 1810-1812, the activation of any of which can allow the user to edit information regarding a particular allergy, remove information about a particular allergy from the patient record 132, or add information about a new allergy to the patient record 132. For example, the user can activate the “EDIT” icon 1810 to edit information regarding a particular allergy, the “REMOVE” icon 1811 to remove information about a particular allergy from the patient record 132, or the “ADD ALLERGY” icon 1812 to add information about a new allergy to the patient record 132.

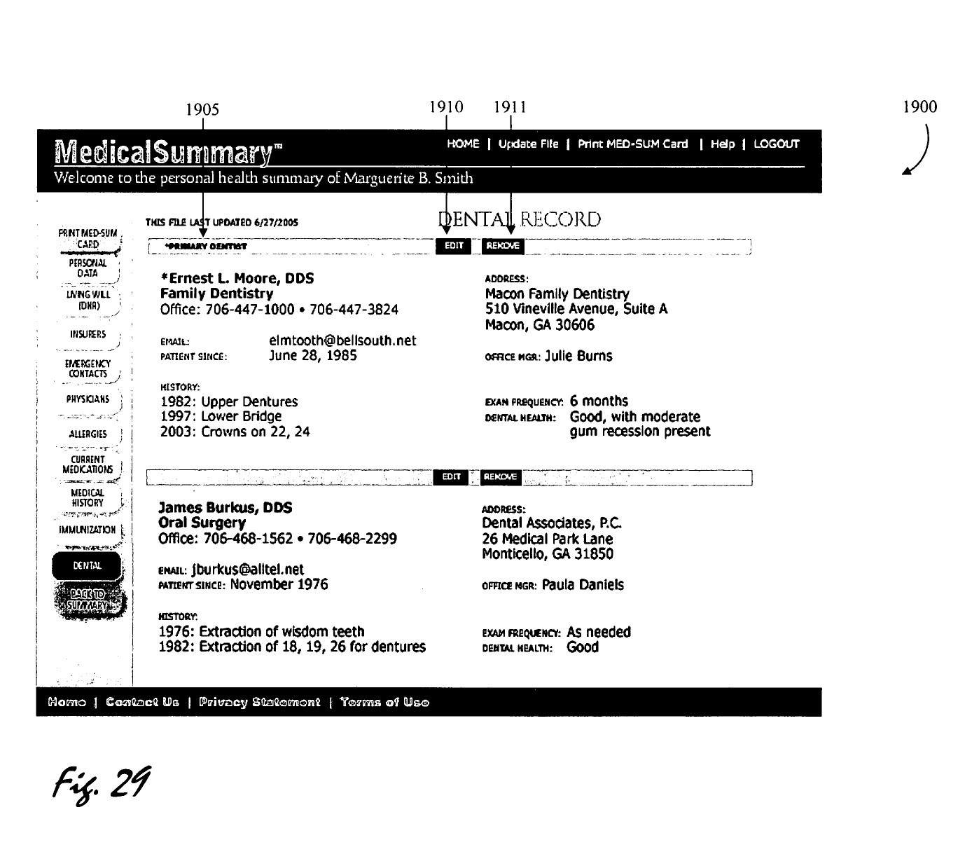

FIG. 29 is an illustrative dental record page 1900 of a system for maintaining and communicating health information, according to an exemplary embodiment of the present invention. The dental record page 1900 is merely illustrative and, in alternative embodiments of the invention, certain elements of the dental record page 1900 can be altered, certain elements can be omitted entirely, and/or certain additional elements can be included.

The dental record page 1900 comprises certain information regarding the patient's dental health, including for example, for each of the patient's dentists, the dentist's name, phone numbers, address, email address, office manager name, and the patient's medical history with each particular dentist, the frequency with which the patient receives dental examinations from each dentist, and general comments about the patient's dental health. The dental record page 1900 can further comprise multiple icons 1910-1911, the activation of any of which can allow the user to edit information regarding a particular dentist or remove information about a particular dentist. For example, the user can activate the “EDIT” icon 1910 to edit information regarding a particular dentist or the “REMOVE” icon 1911 to remove information about a particular dentist from the patient record 132.

In conclusion, the foregoing exemplary embodiments enable a more convenient and effective approach for patients to maintain their health information. By providing a network based application through which patients can maintain, and communicate to designated health care providers, their health information, the present invention enables patients to take more control over their health by keeping themselves and their health care providers informed about their medical needs and medical history. In addition, by allowing health care providers to make updates and/or revisions to the health information, patients can maintain a more accurate record of their health information. By further providing patients the ability to create customized cards comprising certain of their health information, the present invention also enables patients to quickly and efficiently review and communicate their health information, even in emergency situations.

It will be appreciated that the exemplary embodiments of the present invention overcome the limitations of the prior art. From the description of the exemplary embodiments, equivalents of the elements shown therein and ways of constructing other embodiments of the present invention will be apparent to practitioners of the art. Many other modifications, features and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes can be made therein without departing from the spirit and scope of the invention.

We claim:

1. A computer-implemented method for maintaining and communicating patient health information comprising the steps of:
receiving data representing patient health information from a network device via a network;
creating a patient record comprising said data and storing said patient record in a database;
associating a plurality of access privileges with said patient record, each of the access privileges specifying a different type or amount of the data of the patient record that can be viewed, updated and revised; and
providing an interface for allowing a user having appropriate access privileges to create and print a customized card comprising portions of said data selected by said user.

2. The method of claim 1, wherein the patient health information is selected from the group consisting of: patient contact information, age, emergency contact information, physicians, dentists, allergies, medications, medical devices, medical history, immunizations, and health insurance.

3. The method of claim 1, further comprising the steps of receiving personal data from the network device via the network and adding said personal data to the patient record.

4. The method of claim 3, wherein the personal data is selected from the group consisting of patient name, address, telephone number, sex, birth date, blood type, height, weight, social security number, living will information, and organ donor status.

5. The method of claim 1, wherein the interface further allows the user to determine the size and the format of the customized card.

6. The method of claim 1, further comprising the steps of:
designating a selected portion of the patient record as emergency information that would be helpful to a caregiver during a medical emergency;
associating an emergency reference code with said emergency information; and
in response to receiving said emergency reference code from a user device via a network, displaying said emergency information.

7. The method of claim 6, wherein the emergency information is selected from the group consisting of: patient name, emergency contact, allergies, current medications, and medical history.

8. A system for maintaining and communicating health information comprising:
a database for storing a patient record comprising data representing patient health information;
a communications device for communicating with a network device via a network; and
a processing unit in communication with said database and said communications device for executing computer-executable instructions for:
receiving said data from said network device via the communications device,
creating said patient record and storing said patient record in said database,
associating a plurality of access privileges with said patient record, each of the access privileges specifying a different type or amount of the data of the patient record that can be viewed, updated and revised, and
providing an interface for allowing a user having appropriate access privileges to create and print a customized card comprising portions of said data selected by said user.

9. The system of claim 8, wherein the patient health information is selected from the group consisting of: patient contact information, age, emergency contact information, physicians, dentists, allergies, medications, medical devices, medical history, immunizations, and health insurance.

10. The system of claim 8, wherein the processing unit executes further computer-executable instructions for receiving other personal data from the network device via the network and adding said personal data to the patient record.

11. The system of claim 10, wherein the personal data is selected from the group consisting of patient name, address, telephone number, sex, birth date, blood type, height, weight, social security number, living will information, and organ donor status.

12. The system of claim 8, wherein the interface further allows the user to determine the size and the format of the customized card.

13. The system of claim 8, wherein the processing unit executes further computer-executable instructions for:
designating a selected portion of the patient record as emergency information that would be helpful to a caregiver during a medical emergency;
associating an emergency reference code with said emergency information; and
in response to receiving said emergency reference code from a user device via a network, displaying said emergency information.

14. The system of claim 13, wherein the emergency information is selected from the group consisting of: patient name, emergency contact, allergies, current medications, and medical history.

15. A computer-implemented method for maintaining and communicating health information comprising the steps of:
storing a patient record in a database, said patient record comprising data representing patient health information;
designating a selected portion of the patient record as emergency information that would be helpful to a caregiver during a medical emergency;
associating an emergency reference code with said emergency information; and
in response to receiving said emergency reference code from a user device via a network, displaying said emergency information.

16. The method of claim 9, wherein the patient health information is selected from the group consisting of: patient contact information, age, emergency contact information, physicians, dentists, allergies, medications, medical devices, medical history, immunizations, and health insurance.

17. The method of claim 9, wherein the emergency information is selected from the group consisting of: patient name, emergency contact, allergies, current medications, and medical history.

18. The method of claim 9, wherein the patient record further comprises other personal data selected from the group consisting of patient name, address, telephone number, sex, birth date, blood type, height, weight, social security number, living will information, and organ donor status.

19. The method of claim 9, further comprising the step of associating a plurality of access privileges with said patient record, each of the access privileges specifying a different type or amount of the data of the patient record that can be viewed, updated and revised.

20. The method of claim 9, further comprising the step of providing an interface for allowing a user having appropriate access privileges to create and print a customized card comprising portions of said data selected by said user.

21. The method of claim 14, wherein the interface further allows the user to determine the size and the format of the customized card.

22. A system for maintaining and communicating health information comprising:
a database for storing a patient record comprising data representing patient health information;
a communications device for communicating with a network device via a network; and
a processing unit in communication with said database and said communications device for executing computer-executable instructions for:
designating a selected portion of the patient record as emergency information that would be helpful to a caregiver during a medical emergency;
associating an emergency reference code with said emergency information; and
in response to receiving said emergency reference code from a user device via said communications device, displaying said emergency information.

23. The system of claim 22, wherein the patient health information is selected from the group consisting of: patient contact information, age, emergency contact information, physicians, dentists, allergies, medications, medical devices, medical history, immunizations, and health insurance.

24. The system of claim 22, wherein the emergency information is selected from the group consisting of: patient name, emergency contact, allergies, current medications, and medical history.

25. The system of claim 22, wherein the patient record further comprises other personal data selected from the group consisting of patient name, address, telephone number, sex, birth date, blood type, height, weight, social security number, living will information, and organ donor status.

26. The system of claim 22, wherein the processing unit executes further computer-executable instructions for associating a plurality of access privileges with said patient record, each of the access privileges specifying a different type or amount of the data of the patient record that can be viewed, updated and revised.

27. The system of claim 22, further comprising the step of providing an interface for allowing a user having appropriate access privileges to create and print a customized card comprising portions of said data selected by said user.

28. The system of claim 27, wherein the interface further allows the user to determine the size and the format of the customized card.
